(19) United States
(12) Patent Application Publication
(10) Pub. No.: US 2024/0286078 A1
(43) Pub. Date: Aug. 29, 2024

(54) Enrichment Method

(71) Applicants: CAMBRIDGE CENTER FOR ADVANCED RESEARCH AND EDUCATION IN SINGAPORE LTD, Singapore (SG); THE REGENTS OF THE UNIVERSITY OF CALIFORNIA, Oakland, CA (US); THE CHANCELLOR, MASTERS AND SCHOLARS OF THE UNIVERSITY OF CAMBRIDGE, Cambridge (GB)

(72) Inventors: Mikhail KOVALEV, SINGAPORE (SG); Magda Helena BARECKA, SINGAPORE (SG); Hangjuan REN, SINGAPORE (SG); Joel Wheeler AGER, III, Oakland, CA (US); Alexei Alexandrovich LAPKIN, Cambridge (GB)

(21) Appl. No.: 18/572,494

(22) PCT Filed: Jun. 23, 2022
(86) PCT No.: PCT/SG2022/050430

§ 371 Date: Dec. 20, 2023

Related U.S. Application Data
(60) Provisional application No. 63/213,936, filed on Jun. 23, 2021.

(51) Int. Cl. B01D 59/40; C25B 3/26

(52) U.S. Cl. CPC B01D 59/40; C25B 3/26

(57) ABSTRACT

The present invention relates to a method of carbon-13 isotope (13C) enrichment, the method comprising: (i) applying a voltage to a cathode located in a cathode chamber of an electrochemical cell; (ii) flowing a feed stream comprising CO2 to the cathode chamber, wherein the feed stream contacts the cathode causing reduction of CO2 to form one or more products; and (iii) unreacted CO2 leaving the cathode chamber, the unreacted CO2 being enriched in 13C as compared to the CO2 in the feed stream, wherein n(13CO2)/(n(13CO2)+n(12CO2)) in the unreacted CO2 is higher than n(13CO2)/(n(13CO2)+n(12CO2)) in the feed stream, n representing molar amount; wherein the voltage is about 1.5 V to about 5.5 V, and flow rate of the feed stream is selected to provide a residence time of about 0.1 seconds to about 5 seconds in the cathode chamber.

### TECHNICAL FIELD

The present disclosure refers to a method of carbon-13 isotope (¹³C) enrichment. The present disclosure further refers to ¹³CO₂ produced by the method disclosed herein.

### BACKGROUND ART

Carbon-13 (¹³C) is a stable isotope of carbon, used as a tracer element in a wide range of research fields, medicine, pharmaceutical industry, agriculture and others. ¹³C-enriched compounds are safe because they are non-radioactive (as opposed to carbon-14 isotope (¹⁴C)), and hence can be used to quantify proteins, study metabolic processes, amino acids in cell cultures, and in medical diagnostic tests such as the urea breath test for detection of the presence of Helicobacter pylori infection. Carbon-13 is also used in nuclear magnetic resonance (NMR) for investigation of carbon-containing substances.

However, the natural abundance of ¹³C is only around 1.1%. Given the high dilution of ¹³C in the natural environment, the production of this isotope for commercial applications is extremely costly. Out of several methods proposed so far such as thermal diffusion, chemical exchange, gas diffusion, laser distillation and cryogenic distillation, only the latter has found large-scale deployment.

Cryogenic distillation is however, a capital and operationally cost-intensive approach, resulting in a high price of ¹³C and a barrier for many commercial applications described above. The key challenge of this approach is that the feed for the commercially deployed distillation-based production method, either carbon monoxide (CO) or methane (CH₄), contains only 1.1% of ¹³C isotope, and the separation factor between ¹²C and ¹³C is extremely low due to the small difference in mass between the ¹²C and ¹³C isotopes of CO or CH₄. Hence, industrial plants require substantial investments for over 100-meter-tall cryogenic distillation columns. Additionally, based on reports from the industrially deployed process, it is noted that it takes a long time (15 days) to concentrate the ¹³C content in a CO stream from 1.1% to 10%.

Another method is hydration of formic acid with sulfuric acid. However, this method could not find commercial application due to a long, multistep synthesis procedure which does not accelerate the production process as opposed to the distillation-based approach.

Another alternative method of ¹³C enrichment is based on chromatography separation. Similar to the industrial standard for ¹³C enrichment, this method is limited by low separation factor between ¹²C and ¹³C isotopes.

Thus, there is a need to find new methods of concentrating or enriching ¹³C that overcomes or ameliorates at least one of the problems.

### SUMMARY

In one aspect of the present disclosure, there is provided a method of carbon-13 isotope (¹³C) enrichment, the method comprising:
(i) applying a voltage to a cathode located in a cathode chamber of an electrochemical cell;
(ii) flowing a feed stream comprising CO₂ to the cathode chamber, wherein the feed stream contacts the cathode causing reduction of CO₂ to form one or more products; and
(iii) unreacted CO₂ leaving the cathode chamber, the unreacted CO₂ being enriched in ¹³C as compared to the CO₂ in the feed stream, wherein n(¹³CO₂)/(n(¹³CO₂)+n(¹²CO₂)) in the unreacted CO₂ is higher than n(¹³CO₂)/(n(¹³CO₂)+n(¹²CO₂)) in the feed stream, n representing molar amount; wherein the voltage is about 1.5 V to about 5.5 V, and flow rate of the feed stream is selected to provide a residence time of about 0.1 seconds to about 5 seconds in the cathode chamber.

Due to its low natural abundance (c.a. 1.1%), production of carbon-13 is extremely costly, hence a straightforward and economically feasible method for ¹³C enrichment is of interest for several sectors and can further enable new applications of stable isotopes. A method for enrichment of carbon-13 isotope (¹³C) is hence disclosed herein.

The presently disclosed method is an electrochemical process that can advantageously operate with only carbon dioxide (CO₂) and water as consumable feedstocks. By converting CO₂, a greenhouse gas, into useful products like ethanol, acetic acid, ethene, CO and/or H₂ while at the same time producing CO₂ enriched in carbon-13, the presently disclosed method valorizes two cheap and readily available products. For example, the CO₂ from incineration or power generation processes can be directly used as feedstock to be converted to products. In doing so, the presently disclosed method also advantageously reduces the carbon footprint of the above-mentioned incineration and/or power generation processes, while at the same time also reducing the amount of greenhouse gas (CO₂) into the atmosphere.

Being a simple electrochemical process, the presently disclosed method can also be advantageously powered by renewable energy, like solar energy, hydrothermal energy, geothermal energy, wind energy, tidal energy and etc. Additionally, the method can convert renewable energy and CO₂ into above-mentioned useful products, which further reduces the carbon footprint and the environmental impact of the presently disclosed method. By coupling a renewable energy source to an industrial process that releases CO₂ as by-products, the amount of greenhouse gases released to the environment can be advantageously greatly reduced with little to no fossil fuels burnt in the process and is.

Advantageously, the presently disclosed process enriches ¹³CO₂ by discriminating against ¹³CO₂ in electroreduction reactions that take place at the cathode. By selectively electroreducing ¹²CO₂ over ¹³CO₂, the amount of ¹²CO₂ in the feed stream is reduced, while at the same time the ¹³CO₂ in the feed stream leaves the cathode chamber mostly unreacted. Hence, the enrichment of ¹³C is almost immediate as electroreduction takes place almost immediately once the CO₂ contacts the cathode. This is advantageous when compared to cryogenic distillation processes which take a long time to enrich ¹³C content in a CO stream, for example, it takes about 15 days to concentrate the feed from 1.1% to 10%.

Additionally, the presently disclosed method does not require huge distillation columns, and neither does it require intensive cooling operations to maintain the distillation near 80 K. Instead, the presently disclosed method can be advantageously performed at room temperature, meaning no additional thermal energy is required for the process. Additionally, the separation of the unreacted CO₂ in the outlet stream from other by-products and inert gases can be advantageously performed by condensation or membrane processes. In comparison, the industrial enrichment of carbon-13 by separation of ¹³CO and ¹²CO requires long and arduous cryogenic distillation for up to 400 hours.

Further, as the presently disclosed method does not require intensive cooling and distillation operations, the presently disclosed method is also advantageously cheaper as compared to the present method for enriching carbon-13.

The presently disclosed method also advantageously reduces ¹²CO₂ into liquid and gaseous products like ethanol and acetic acid. Ethanol is an important intermediate in the production of other chemicals, for example drugs, plastics, lacquers, plasticizers, cosmetics, etc. Additionally, ethanol is an industrial solvent due to its amphiphilic properties. Acetic acid is also an important intermediate in various industrial sectors like pharmaceutical, polymers, textiles, cosmetics, chemical and food.

In another aspect of the present disclosure, there is provided ¹³CO₂ produced by the method disclosed herein.

The ¹³C-enriched product can be advantageously used in many different applications, for example in drug discovery and validation, reaction mechanism studies, ¹³C-MRI radiology and medical diagnosis.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

The word “substantially” does not exclude “completely” e.g. a composition which is “substantially free” from Y may be completely free from Y. Where necessary, the word “substantially” may be omitted from the definition of the invention.

As used herein, the term “enrichment” refers to increasing the proportion of ¹³C, relative to ²C, in a carbon dioxide sample.

As used herein, the term “flow cell voltage” refers to the voltage measured across an electrochemical flow cell between the cathode and the anode.

As used herein, the term “cathode surface area” refers to the macroscopic surface area of the cathode that is in contact with feed stream.

As used herein, the term “residence time” refers to the duration that a molecule in the feed stream spends inside the cathode chamber. The residence time is also intended to refer to the mean residence time of all the molecules in the feed stream and may be calculated using the formula as shown in the Examples to follow.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1 is a diagram showing an embodiment for enriching ¹³C from CO₂ using the method of the present invention.

FIG. 2 is a diagram showing a further embodiment for enriching ¹³C from CO₂ using the method of the present invention.

FIG. 3 is a Scanning Electron Microscopy (SEM) image of a Gas Diffusion Electrode (GDE) of the present invention, with (A) indicating the carbon paper filament and (B) indicating the sprayed catalyst (metal nanoparticle)/Carbon Black/graphite layers. This GDE corresponds to GDE-1 of Table 4.

FIG. 4 is a SEM image showing the top view of GDE-1 from the graphite side.

FIG. 5a is a graph showing Δ¹³C of the examples having an initial ¹³C content of 1.11% in Table 5.

FIG. 5b is a graph showing Δ¹³C over the residence time for the examples in Table 5.

FIG. 5c is a graph showing Δ¹³C over energy consumption for the examples in Table 5.

FIG. 5d is a graph showing Δ13C over the flow cell voltage at different flow rates with GDE-1.

FIG. 5e is a graph showing Δ13C over the flow cell voltage at different flow rates with GDE-3.

FIG. 6a is a graph showing the flow cell voltage-dependent enrichment at higher initial ¹³C concentration at a flow rate of 30 sccm.

FIG. 6b is a graph showing Δ¹³C at different initial ¹³C concentrations.

FIG. 6c is a graph showing the Δ¹³C over residence time and energy consumption at different initial ¹³C concentrations.

FIG. 7 is a diagram showing δ¹³C in Example 4f.

FIG. 8a is the gas chromatogram of the main reduction products using GDE-3.

FIG. 8b is the gas chromatogram of main reduction products using GDE-1.

### DETAILED DISCLOSURE OF DRAWINGS

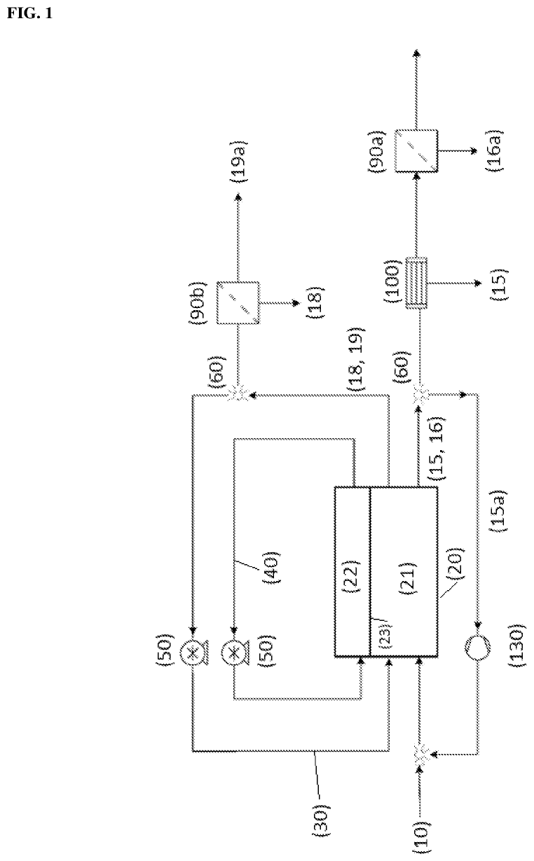

Referring to FIG. 1, water vapour and CO₂ feed stream (10) are fed to a reactor (20) comprising a cathode chamber (21) and anode chamber (22). The cathode chamber (21) and anode chamber (22) are separated by an ion exchange membrane (23). The CO₂ feed stream (10) contacts the cathode (not depicted) causing reduction of CO₂ to form one or more products. Unreacted CO₂ (15) and gaseous products (16) leave the cathode chamber (21). Unreacted CO₂ (15a) may be recirculated as feed stream and fed to the reactor (20) a second time. This recirculation step may be repeated multiple times. Unreacted CO₂ is increasingly enriched with ¹³C with each pass. Alternatively, or after one or more recirculations, unreacted CO₂ (15) and gaseous products (16) may pass through a liquid nitrogen cooling unit (100) to separate the unreacted CO₂ (15) from gaseous products (16). The unreacted CO₂ (15) is enriched with ¹³C with (15) being more enriched in ¹³C than (10). The separated gaseous products (16) may pass through a membrane unit (90a) to separate syngas components such as CO and H₂ (16a) for other uses. Liquid products (18) may leave the cathode chamber (21) together with catholyte (19). Liquid products (18) (such as ethanol) may be separated from catholyte (19) via a membrane unit (90b). The separated catholyte (19a) may be removed as alkaline waste and valorized. Alternatively, the separated catholyte (19a) may be recirculated back to the cathode chamber (21) (not depicted). Catholyte (19) may also be recirculated via a catholyte line (30) to the cathode chamber (21). Anolyte may also be recirculated to the anode chamber (22) via an anolyte line (40). (50) represents a liquid pump, (60) represents a 3-way valve, and (130) represents a gas pump/compressor.

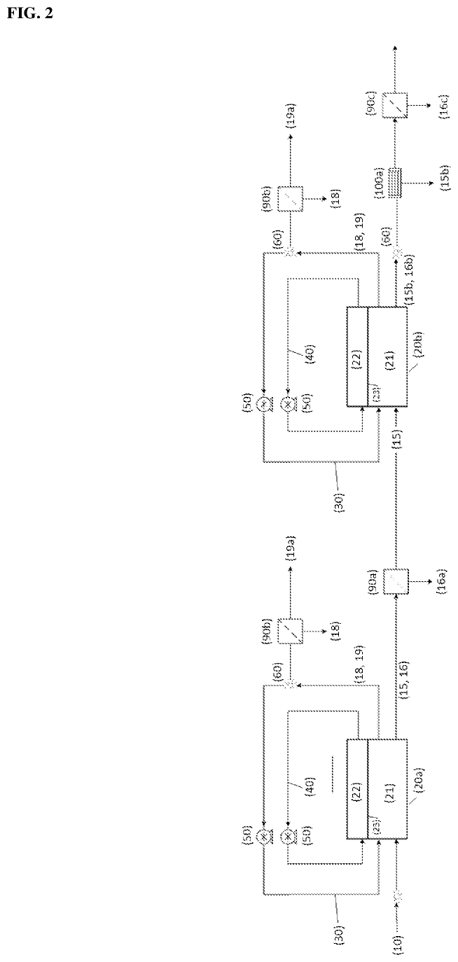

FIG. 2 shows another embodiment of the present invention. Water vapour and CO₂ feed stream (10) are fed to a reactor (20a) comprising a cathode chamber (21) and anode chamber (22). The cathode chamber (21) and anode chamber (22) are separated by an ion exchange membrane (23). The CO₂ feed stream (10) contacts the cathode (not depicted) causing reduction of CO₂ to form one or more products. Unreacted CO₂ (15) and gaseous products (16) leave the cathode chamber (21). Unreacted CO₂ and gaseous products (16) may pass through a membrane unit (90a) to separate syngas components such as CO and H₂ (16a) for other uses. Unreacted CO₂ (15) is fed as feed stream to a second reactor (20b) where the same reaction is repeated. Unreacted CO₂ (15b) and gaseous products (16b) may pass through a liquid nitrogen cooling unit (100a) to separate the unreacted CO₂ (15b) from gaseous products (16b). The unreacted CO₂ (15, 15b) is enriched with ¹³C with (15) being more enriched than (10) and (15b) being more enriched than (15). The separated gaseous products (16b) may pass through a membrane unit (90c) to separate syngas components such as CO and H₂ (16c) for other uses. Liquid products (18) may leave the cathode chamber together with catholyte (19). Liquid products (18) (such as ethanol) may be separated from catholyte (19) via a membrane unit (90b). The separated catholyte (19a) may be removed as alkaline waste and valorized. Alternatively, the separated catholyte (19a) may be recirculated back to the cathode chamber (21) (not depicted). Catholyte (19) may also be recirculated via a catholyte line (30) to the cathode chamber (21). Anolyte may also be recirculated to the anode chamber (22) via an anolyte line (40). (50) represents a liquid pump, (60) represents a 3-way valve, and (130) represents a gas pump/compressor.

### Detailed Disclosure of Embodiments

It is known that 3 isotopes of carbon exist in nature, of which two isotopes (¹²C and ¹³C) are naturally stable, while the last isotope ¹⁴C is radioactive in nature. ¹²C has a natural abundance of 98.9%, while ¹³C has a natural abundance of 1.1%. The radioactive ¹⁴C instead has a small abundance of 10⁻¹⁰%.

The only industrially deployed method for ¹³C production is cryogenic distillation, a capital and operationally cost-intensive approach, resulting in a high price of ¹³C and a barrier for many commercial applications described above. Another alternative method of ¹³C production is based on chromatography separation. Similar to the industrial standard for ¹³C production, this method is limited by low separation factor between ¹²C and ¹³C isotopes.

The cryogenic industrial process involves multistage distillation columns with heights of at least 39 m, and diameters of at least 72 mm. CO possesses the best volatility among the various carbon-containing gases, hence it is commonly chosen as the reagent for cryogenic distillation. However, in a first stage run, it would typically take about 400 hours to enrich about 5% of ¹³CO₂. In order to reach 99% enrichment, it may over a month of distillation.

The present invention generally relates to a method of ¹³C enrichment, or improving separation efficiency of ¹³CO₂ from CO₂. Enrichment or separation efficiency is improved through careful selection of one or more parameters, such as applied potential (or current density), type of electrode, residence time of CO₂ in the cathode chamber (or flow rate), electrolyte type, concentration of electrolyte, and/or catalyst concentration.

The inventors have surprisingly found that in the method of the present invention, products containing one or more atoms of carbon are preferentially formed from ¹²C and not ¹³C. As a result, the remaining CO₂ that is not converted to product (for example, ethylene, ethanol, CO, acetic acid, etc.) has a higher content of ¹³C. This ¹³C enriched CO₂ can be used to feed a commercial process for producing ¹³C labelled compounds and drastically reduce the processing cost for example or can be directly sold to end users such as pharmaceutical industries. Importantly, the presently disclosed method leading to enrichment of ¹³C is very fast and can be completed, based on the desired conversion rate, in at most several hours.

Currently deployed methods for ¹³C production are all limited by very low separation factors between ¹²C and ¹³C resulting from the similarity in physical properties of the two isotopes. On the contrary, the presently disclosed method explores the difference in reactivity of isotopes towards the products of electrochemical reactions, which enables fast and selective discrimination between the isotopes. Furthermore, the presently disclosed process uses an abundant and low-cost feedstock (CO₂), while at the time producing value-added chemicals such as ethylene and ethanol, further improving the overall techno-economic performance.

The presently disclosed method is much simpler compared to conventional cryogenic distillation processes as the presently disclosed method does not require huge distillation columns. Additionally, the system containing the presently disclosed electrochemical cell does not require large amounts of space and heat isolation among others. The unreacted CO₂ from the method may be further enriched in ¹³C by recycling back the unreacted CO₂ as the feed stream in the same electrochemical cell, or may be fed as a feed stream into a second electrochemical cell in a series of consecutive cells. The presently disclosed method also requires less time to enrich the same amount of ¹³C when compared to cryogenic distillation as enrichment of ¹³C in the present invention is almost immediate when CO₂ contacts the cathode and selectively forms ¹²C reduction products.

The present invention relates to a method of carbon-13 isotope (¹³C) enrichment, the method comprising:
(i) applying a voltage to a cathode located in a cathode chamber of an electrochemical cell;
(ii) flowing a feed stream comprising CO₂ to the cathode chamber, wherein the feed stream contacts the cathode causing reduction of CO₂ to form one or more products; and
(iii) unreacted CO₂ leaving the cathode chamber, the unreacted CO₂ being enriched in ¹³C as compared to the CO₂ in the feed stream, wherein n(¹³CO₂)/(n(¹³CO₂)+n(¹²CO₂)) in the unreacted CO₂ is higher than n(¹³CO₂)/(n(¹³CO₂)+n(¹²CO₂)) in the feed stream, n representing molar amount; wherein the voltage is about 1.5 V to about 5.5 V, and flow rate of the feed stream is selected to provide a residence time of about 0.1 seconds to about 5 seconds in the cathode chamber.

The unreacted CO₂ may also be referred to as an “outlet stream”. Products produced by the reduction process may be referred to as a “product stream”. The product stream may be a liquid or gaseous product stream. There may be more than one product stream. The stream leaving the cathode may contain outlet stream and gaseous product stream. The stream leaving the anode may contain liquid product stream.

The feed stream may be a feed stream comprising pure CO₂, or a feed stream comprising from about 0.1% CO₂ to about 100% CO₂. The remaining components of the feed stream may comprise a gas that is either inert to the electroreduction process like N₂, Ar, Ne, He, or may comprise a gas that is a co-feed to the electro-reduction process like CO. The feed stream may be a previously processed gas stream, or taken as-is from a prior manufacturing process. The feed stream may come as a by-product stream, but is not limited to a stream resulting from natural gas extraction, biogas production, fermentation process, corn-based ethanol production, combustion process during energy production, waste incineration, ammonia production, ethylene oxide production, vinyl acetate monomer production, synthetic fuel production, hydrogen production, syngas production, or methanol-base fuel cell use.

In some embodiments, the feed stream may comprise CO₂ by v/v % basis, in a range of at least about 0.1 v/v %, at least about 1 v/v %, at least about 5 v/v %, at least about 10 v/v %, at least about 20 v/v %, at least about 40 v/v %, at least about 60 v/v %, at least about 80 v/v %, at least about 100 v/v %; or from about 0.1 v/v % to about 100 v/v %, from about 0.1 v/v % to about 80 v/v %, from about 0.1 v/v % to about 60 v/v %, from about 0.1 v/v % to about 40 v/v %, from about 0.1 v/v % to about 20 v/v %, from about 0.1 v/v % to about 10 v/v %, from about 0.1 v/v % to about 5 v/v %, from about 0.1 v/v % to about 1 v/v %, from about 1 v/v % to about 100 v/v %, from about 1 v/v % to about 80 v/v %, from about 1 v/v % to about 60 v/v %, from about 1 v/v % to about 40 v/v %, from about 1 v/v % to about 20 v/v %, from about 1 v/v % to about 10 v/v %, from about 1 v/v % to about 5 v/v %, from about 5 v/v % to about 100 v/v %, from about 5 v/v % to about 80 v/v %, from about 5 v/v % to about 60 v/v %, from about 5 v/v % to about 40 v/v %, from about 5 v/v % to about 20 v/v %, from about 5 v/v % to about 10 v/v %, from about 10 v/v % to about 100 v/v %, from about 10 v/v % to about 80 v/v %, from about 10 v/v % to about 60 v/v %, from about 10 v/v % to about 40 v/v %, from about 10 v/v % to about 20 v/v %, from about 20 v/v % to about 100 v/v %, from about 20 v/v % to about 80 v/v %, from about 20 v/v % to about 60 v/v %, from about 20 v/v % to about 40 v/v %, from about 40 v/v % to about 100 v/v %, from about 40 v/v % to about 80 v/v %, from about 40 v/v % to about 60 v/v %, from about 60 v/v % to about 100 v/v %, from about 60 v/v % to about 80 v/v %, from about 80 v/v % to about 100 v/v %; or at most about 0.1 v/v %, at most about 1 v/v %, at most about 5 v/v %, at most about 10 v/v %, at most about 20 v/v %, at most about 40 v/v %, at most about 60 v/v %, at most about 80 v/v %, at most about 100 v/v %; or about 0.1 v/v %, about 1 v/v %, about 5 v/v %, about 10 v/v %, about 20 v/v %, about 40 v/v %, about 60 v/v %, about 80 v/v %, about 100 v/v %, or any ranges or values therebetween.

In some other embodiments, the feed stream may comprise CO₂ with an initial ¹³C content in a range of at least about 0.5%, at least about 1%, at least about 1.1%, at least about 5.58%, at least about 10%, at least about 30%, at least about 50%, at least about 70%, at least about 88.48%, at least about 95%, at least about 99%; or from about 0.5% to about 99%, from about 0.5% to about 95%, from about 0.5% to about 88.48%, from about 0.5% to about 70%, from about 0.5% to about 50%, from about 0.5% to about 30%, from about 0.5% to about 10%, from about 0.5% to about 5.58%, from about 0.5% to about 1%, from about 1% to about 99%, from about 1% to about 95%, from about 1% to about 88.48%, from about 1% to about 70%, from about 1% to about 50%, from about 1% to about 30%, from about 1% to about 10%, from about 1% to about 5.58%, from about 5.58% to about 99%, from about 5.58% to about 95%, from about 5.58% to about 88.48%, from about 5.58% to about 70%, from about 5.58% to about 50%, from about 5.58% to about 30%, from about 5.58% to about 10%, from about 10% to about 99%, from about 10% to about 95%, from about 10% to about 88.48%, from about 10% to about 70%, from about 10% to about 50%, from about 10% to about 30%, from about 30% to about 99%, from about 30% to about 95%, from about 30% to about 88.48%, from about 30% to about 70%, from about 30% to about 50%, from about 50% to about 99%, from about 50% to about 95%, from about 50% to about 88.48%, from about 50% to about 70%, from about 70% to about 99%, from about 70% to about 95%, from about 70% to about 88.48%, from about 88.48% to about 99%, from about 88.48% to about 95%, from about 95% to about 99%; or at most about 0.5%, at most about 1%, at most about 5.58%, at most about 10%, at most about 30%, at most about 50%, at most about 70%, at most about 88.48%, at most about 95%, at most about 99%; or about 0.5%, about 1%, about 5.58%, about 10%, about 30%, about 50%, about 70%, about 88.48%, about 95%, about 99%, or any ranges or values therebetween.

Both the flow cell voltage applied across the electrochemical cell and the current density may affect the rate of electroreduction that happens at the cathode. As flow cells may come in different sizes, the measure of current density at the electrode is more useful than current alone for tuning the rate of electroreduction that happens at the cathode.

In some embodiments, the current density may be relative to the cathode surface area, in the range of at least about 0.1 A/cm², at least about 0.2 A/cm², at least about 0.3 A/cm², at least about 0.5 A/cm², at least about 0.75 A/cm², at least about 1 A/cm², at least about 1.25 A/cm², at least about 1.5 A/cm², at least about 1.8 A/cm², at least about 2 A/cm²; or from about 0.1 A/cm² to about 2 A/cm², from about 0.1 A/cm² to about 1.8 A/cm², from about 0.1 A/cm² to about 1.5 A/cm², from about 0.1 A/cm² to about 1.25 A/cm², from about 0.1 A/cm² to about 1 A/cm², from about 0.1 A/cm² to about 0.75 A/cm², from about 0.1 A/cm² to about 0.5 A/cm², from about 0.1 A/cm² to about 0.3 A/cm², from about 0.1 A/cm² to about 0.2 A/cm², from about 0.2 A/cm² to about 2 A/cm², from about 0.2 A/cm² to about 1.8 A/cm², from about 0.2 A/cm² to about 1.5 A/cm², from about 0.2 A/cm² to about 1.25 A/cm², from about 0.2 A/cm² to about 1 A/cm², from about 0.2 A/cm² to about 0.75 A/cm², from about 0.2 A/cm² to about 0.5 A/cm², from about 0.2 A/cm² to about 0.3 A/cm², from about 0.3 A/cm² to about 2 A/cm², from about 0.3 A/cm² to about 1.8 A/cm², from about 0.3 A/cm² to about 1.5 A/cm², from about 0.3 A/cm² to about 1.25 A/cm², from about 0.3 A/cm² to about 1 A/cm², from about 0.3 A/cm² to about 0.75 A/cm², from about 0.3 A/cm² to about 0.5 A/cm², from about 0.5 A/cm² to about 2 A/cm², from about 0.5 A/cm² to about 1.8 A/cm², from about 0.5 A/cm² to about 1.5 A/cm², from about 0.5 A/cm² to about 1.25 A/cm², from about 0.5 A/cm² to about 1 A/cm², from about 0.5 A/cm² to about 0.75 A/cm², from about 0.75 A/cm² to about 2 A/cm², from about 0.75 A/cm² to about 1.8 A/cm², from about 0.75 A/cm² to about 1.5 A/cm², from about 0.75 A/cm² to about 1.25 A/cm², from about 0.75 A/cm² to about 1 A/cm², from about 1 A/cm² to about 2 A/cm², from about 1 A/cm² to about 1.8 A/cm², from about 1 A/cm² to about 1.5 A/cm², from about 1 A/cm² to about 1.25 A/cm², from about 1.25 A/cm² to about 2 A/cm², from about 1.25 A/cm² to about 1.8 A/cm², from about 1.25 A/cm² to about 1.5 A/cm², from about 1.5 A/cm² to about 2 A/cm², from about 1.5 A/cm² to about 1.8 A/cm², from about 1.8 A/cm² to about 2 A/cm²; or at most about 0.1 A/cm², at most about 0.2 A/cm², at most about 0.3 A/cm², at most about 0.5 A/cm², at most about 0.75 A/cm², at most about 1 A/cm², at most about 1.25 A/cm², at most about 1.5 A/cm², at most about 1.8 A/cm², at most about 2 A/cm²; or about 0.1 A/cm², about 0.2 A/cm², about 0.3 A/cm², about 0.5 A/cm², about 0.75 A/cm², about 1 A/cm², about 1.25 A/cm², about 1.5 A/cm², about 1.8 A/cm², about 2 A/cm², or any ranges or values therebetween. In a preferred embodiment, the present disclosure discloses a method wherein a current is passed through the cathode and current density is about 0.3 A/cm² to about 1.8 A/cm² of cathode surface area.

The flow rate of the feed stream is selected to provide a desired residence time. The residence time may be calculated using the formula below, wherein the internal volume of the cathode chamber is calculated by measuring the length, and depth of the channel and then subsequently calculating its volume.

$$residence time = \frac{i n t ernal volume of cathode chamber}{v o l u m etric flow rate}$$

The residence time may be in the range of at least about 0.1 seconds, at least about 0.2 seconds, at least about 0.28 seconds, at least about 0.42 seconds, at least about 0.6 seconds, at least about 0.7 seconds, at least about 0.8 seconds, at least about 1 second, at least about 1.25 seconds, at least about 1.5 seconds, at least about 2 seconds, at least about 3 seconds, at least about 5 seconds, at least about 10 seconds; or from about 0.1 seconds to about 10 seconds, from about 0.1 seconds to about 5 seconds, from about 0.1 seconds to about 3 seconds, from about 0.1 seconds to about 2 seconds, from about 0.1 seconds to about 1.5 seconds, from about 0.1 seconds to about 1.25 seconds, from about 0.1 seconds to about 1 second, from about 0.1 seconds to about 0.8 seconds, from about 0.1 seconds to about 0.7 seconds, from about 0.1 seconds to about 0.6 seconds, from about 0.1 seconds to about 0.42 seconds, from about 0.1 seconds to about 0.28 seconds, from about 0.1 seconds to about 0.2 seconds, from about 0.2 seconds to about 10 seconds, from about 0.2 seconds to about 5 seconds, from about 0.2 seconds to about 3 seconds, from about 0.2 seconds to about 2 seconds, from about 0.2 seconds to about 1.5 seconds, from about 0.2 seconds to about 1.25 seconds, from about 0.2 seconds to about 1 second, from about 0.2 seconds to about 0.8 seconds, from about 0.2 seconds to about 0.7 seconds, from about 0.2 seconds to about 0.6 seconds, from about 0.2 seconds to about 0.42 seconds, from about 0.2 seconds to about 0.28 seconds, from about 0.28 seconds to about 10 seconds, from about 0.28 seconds to about 5 seconds, from about 0.28 seconds to about 3 seconds, from about 0.28 seconds to about 2 seconds, from about 0.28 seconds to about 1.5 seconds, from about 0.28 seconds to about 1.25 seconds, from about 0.28 seconds to about 1 second, from about 0.28 seconds to about 0.8 seconds, from about 0.28 seconds to about 0.7 seconds, from about 0.28 seconds to about 0.6 seconds, from about 0.28 seconds to about 0.42 seconds, from about 0.42 seconds to about 10 seconds, from about 0.42 seconds to about 5 seconds, from about 0.42 seconds to about 3 seconds, from about 0.42 seconds to about 2 seconds, from about 0.42 seconds to about 1.5 seconds, from about 0.42 seconds to about 1.25 seconds, from about 0.42 seconds to about 1 second, from about 0.42 seconds to about 0.8 seconds, from about 0.42 seconds to about 0.7 seconds, from about 0.42 seconds to about 0.6 seconds, from about 0.6 seconds to about 10 seconds, from about 0.6 seconds to about 5 seconds, from about 0.6 seconds to about 3 seconds, from about 0.6 seconds to about 2 seconds, from about 0.6 seconds to about 1.5 seconds, from about 0.6 seconds to about 1.25 seconds, from about 0.6 seconds to about 1 second, from about 0.6 seconds to about 0.8 seconds, from about 0.6 seconds to about 0.7 seconds, from about 0.7 seconds to about 10 seconds, from about 0.7 seconds to about 5 seconds, from about 0.7 seconds to about 3 seconds, from about 0.7 seconds to about 2 seconds, from about 0.7 seconds to about 1.5 seconds, from about 0.7 seconds to about 1.25 seconds, from about 0.7 seconds to about 1 second, from about 1 second to about 10 seconds, from about 1 second to about 5 seconds, from about 1 second to about 3 seconds, from about 1 second to about 2 seconds, from about 1 second to about 1.5 seconds, from about 1 second to about 1.25 seconds, from about 1.25 seconds to about 10 seconds, from about 1.25 seconds to about 5 seconds, from about 1.25 seconds to about 3 seconds, from about 1.25 seconds to about 2 seconds, from about 1.25 seconds to about 1.5 seconds, from about 1.5 seconds to about 10 seconds, from about 1.5 seconds to about 5 seconds, from about 1.5 seconds to about 3 seconds, from about 1.5 seconds to about 2 seconds, from about 2 seconds to about 10 seconds, from about 2 seconds to about 5 seconds, from about 2 seconds to about 3 seconds, from about 3 seconds to about 10 seconds, from about 3 seconds to about 5 seconds, from about 5 seconds to about 10 seconds; or at most about 0.1 seconds, at most about 0.2 seconds, at most about 0.28 seconds, at most about 0.42 seconds, at most about 0.6 seconds, at most about 0.7 seconds, at most about 0.8 seconds, at most about 1 second, at most about 1.25 seconds, at most about 1.5 seconds, at most about 2 seconds, at most about 3 seconds, at most about 5 seconds, at most about 10 seconds; or about 0.1 seconds, about 0.2 seconds, about 0.28 seconds, about 0.42 seconds, about 0.6 seconds, about 0.7 seconds, about 0.8 seconds, about 1 second, about 1.25 seconds, about 1.5 seconds, about 2 seconds, about 3 seconds, about 5 seconds, about 10 seconds, or any ranges or values therebetween. In a preferred embodiment the present disclosure discloses a method wherein the flow rate of the feed stream is selected to provide a residence time of about 0.1 seconds to about 5 seconds in the cathode chamber.

The feed stream flow rate may be broadly defined in terms of a volume of gas that passes through the internal volume of the cathode chamber in a unit of time. It is however well known in the art that the density, and consequently the pressure of the gas is affected by its temperature. Due to fluctuations in the environment and the electroreduction process, the density of the gases at the inlet, inside the cathode chamber and the outlet may deviate slightly from the norm. Hence, to better account for such deviations during the electroreduction, the feed stream and outlet stream may instead be defined in standardised volumetric flow rate, also referred to as mass flow rate.

The mass flow rate refers to the mass of gas that flows through a point and can be defined either in terms of the mass of a gas over a period of time, or the corresponding volume of a gas over the same period of time under standard temperature and pressure (STP, 25° C., 1 atm) conditions. Unless specified otherwise, all flow rates disclosed throughout the specification are intended to mean standardised volumetric flow rates.

The feed stream may thus be defined in terms of a mass flow rate, being the mass of gas that passes through the gas inlet of the cathode chamber in a unit of time. The feed stream may thus also be further defined in terms of a standardised volumetric flow rate, being the volume of a mass of gas that passes through the internal volume of the cathode chamber in a unit of time, as if it was under STP conditions.

The flow rate of CO₂ in the outlet stream may be defined in terms of a mass flow rate, being the mass of CO₂ that passes through the gas outlet of the cathode chamber in a unit of time. The flow rate of CO₂ in the outlet stream may also be further defined in terms of a standardised volumetric flow rate, being the volume of a mass of CO₂ that passes through the gas outlet of the cathode chamber in a unit of time, as if it was under STP conditions.

Using an internal volume of 0.35 cm³ as an example, the feed stream flow rate may be a standardised volumetric flow rate in standard cubic centimetres per minute (sccm or cm³/minute), in a range of at least about 5 sccm, at least about 10 sccm, at least about 20 sccm, at least about 30 sccm, at least about 40 sccm, at least about 50 sccm, at least about 60 sccm, at least about 75 sccm, at least about 100 sccm, at least about 120 sccm; or from about 5 sccm to about 120 sccm, from about 5 sccm to about 100 sccm, from about 5 sccm to about 75 sccm, from about 5 sccm to about 60 sccm, from about 5 sccm to about 50 sccm, from about 5 sccm to about 40 sccm, from about 5 sccm to about 30 sccm, from about 5 sccm to about 20 sccm, from about 5 sccm to about 10 sccm, from about 10 sccm to about 120 sccm, from about 10 sccm to about 100 sccm, from about 10 sccm to about 75 sccm, from about 10 sccm to about 60 sccm, from about 10 sccm to about 50 sccm, from about 10 sccm to about 40 sccm, from about 10 sccm to about 30 sccm, from about 10 sccm to about 20 sccm, from about 20 sccm to about 120 sccm, from about 20 sccm to about 100 sccm, from about 20 sccm to about 75 sccm, from about 20 sccm to about 60 sccm, from about 20 sccm to about 50 sccm, from about 20 sccm to about 40 sccm, from about 20 sccm to about 30 sccm, from about 30 sccm to about 120 sccm, from about 30 sccm to about 100 sccm, from about 30 sccm to about 75 sccm, from about 30 sccm to about 60 sccm, from about 30 sccm to about 50 sccm, from about 30 sccm to about 40 sccm, from about 40 sccm to about 120 sccm, from about 40 sccm to about 100 sccm, from about 40 sccm to about 75 sccm, from about 40 sccm to about 60 sccm, from about 40 sccm to about 50 sccm, from about 50 sccm to about 120 sccm, from about 50 sccm to about 100 sccm, from about 50 sccm to about 75 sccm, from about 50 sccm to about 60 sccm, from about 60 sccm to about 120 sccm, from about 60 sccm to about 100 sccm, from about 60 sccm to about 75 sccm, from about 75 sccm to about 120 sccm, from about 75 sccm to about 100 sccm, from about 100 sccm to about 120 sccm; or at most about 5 sccm, at most about 10 sccm, at most about 20 sccm, at most about 30 sccm, at most about 40 sccm, at most about 50 sccm, at most about 60 sccm, at most about 75 sccm, at most about 100 sccm, at most about 120 sccm; or about 5 sccm, about 10 sccm, about 20 sccm, about 30 sccm, about 40 sccm, about 50 sccm, about 60 sccm, about 75 sccm, about 100 sccm, about 120 sccm, or any ranges or values therebetween.

The internal volume of the cathode chamber and the flow rate determines how long the CO₂ stream resides in the cathode chamber (and at the liquid-gas interface on the cathode). Generally, a longer residence time results in a better Δ¹³C as the CO₂ resides in the cathode chamber long enough for the reaction to effectively discriminate against ¹³CO₂ and favor reduction of ¹²CO₂. The residence time is inversely proportionate to the flow rate of the feed stream.

In some embodiments, to promote the electro-reduction of CO₂ to useful products, the cathode chamber may comprise a liquid catholyte comprising an alkali. The alkali may be a metal hydroxide, more preferably a metal hydroxide selected from the group comprising a Group (I) hydroxide, a Group (II) hydroxide, a Group (III) hydroxide or a Group (IV) hydroxide. In some preferred embodiments, the present disclosure discloses a method wherein the cathode chamber comprises a catholyte, wherein the catholyte is a hydroxide selected from the group consisting of NaOH, KOH, CsOH, Ca(OH)₂, and mixtures thereof. In some further preferred embodiments, the present disclosure discloses a method wherein the cathode chamber comprises a liquid catholyte, wherein the liquid catholyte is a hydroxide selected from the group consisting of NaOH, KOH, CsOH, Ca(OH)₂, and mixtures thereof.

In some other embodiments, the anode chamber may comprise a liquid anolyte comprising an alkali metal hydroxide. The alkali may be a metal hydroxide, more preferably a metal hydroxide selected from the group comprising a Group (I) hydroxide, a Group (II) hydroxide, a Group (III) hydroxide or a Group (IV) hydroxide. In some preferred embodiments, the present disclosure discloses a method wherein the anode chamber comprises a liquid anolyte, wherein the liquid anolyte is a hydroxide selected from the group consisting of NaOH, KOH, CsOH, Ca(OH)₂, and mixtures thereof.

In some other embodiments, the present disclosure discloses a method wherein the catholyte used is the same as the anolyte.

In some embodiments, the concentration of the hydroxide in the catholyte and/or anolyte may be in the range of at least about 0.5 M, at least about 1 M, at least about 2 M, at least about 3 M, at least about 4 M, at least about 5 M, at least about 6 M, at least about 7 M, at least about 8 M, at least about 9 M, at least about 10 M, at least about 12 M; or from about 0.5 M to about 12 M, from about 0.5 M to about 10 M, from about 0.5 M to about 9 M, from about 0.5 M to about 8 M, from about 0.5 M to about 7 M, from about 0.5 M to about 6 M, from about 0.5 M to about 5 M, from about 0.5 M to about 4 M, from about 0.5 M to about 3 M, from about 0.5 M to about 2 M, from about 0.5 M to about 1 M, from about 1 M to about 12 M, from about 1 M to about 10 M, from about 1 M to about 9 M, from about 1 M to about 8 M, from about 1 M to about 7 M, from about 1 M to about 6 M, from about 1 M to about 5 M, from about 1 M to about 4 M, from about 1 M to about 3 M, from about 1 M to about 2 M, from about 2 M to about 12 M, from about 2 M to about 10 M, from about 2 M to about 9 M, from about 2 M to about 8 M, from about 2 M to about 7 M, from about 2 M to about 6 M, from about 2 M to about 5 M, from about 2 M to about 4 M, from about 2 M to about 3 M, from about 3 M to about 12 M, from about 3 M to about 10 M, from about 3 M to about 9 M, from about 3 M to about 8 M, from about 3 M to about 7 M, from about 3 M to about 6 M, from about 3 M to about 5 M, from about 3 M to about 4 M, from about 4 M to about 12 M, from about 4 M to about 10 M, from about 4 M to about 9 M, from about 4 M to about 8 M, from about 4 M to about 7 M, from about 4 M to about 6 M, from about 4 M to about 5 M, from about 5 M to about 12 M, from about 5 M to about 10 M, from about 5 M to about 9 M, from about 5 M to about 8 M, from about 5 M to about 7 M, from about 5 M to about 6 M, from about 6 M to about 12 M, from about 6 M to about 10 M, from about 6 M to about 9 M, from about 6 M to about 8 M, from about 6 M to about 7 M, from about 7 M to about 12 M, from about 7 M to about 10 M, from about 7 M to about 9 M, from about 7 M to about 8 M, from about 8 M to about 12 M, from about 8 M to about 10 M, from about 8 M to about 9 M, from about 9 M to about 12 M, from about 9 M to about 10 M, from about 10 M to about 12 M; or at most about 0.5 M, at most about 1 M, at most about 2 M, at most about 3 M, at most about 4 M, at most about 5 M, at most about 6 M, at most about 7 M, at most about 8 M, at most about 9 M, at most about 10 M, at most about 12 M; or about 0.5 M, about 1 M, about 2 M, about 3 M, about 4 M, about 5 M, about 6 M, about 7 M, about 8 M, about 9 M, about 10 M, about 12 M, or any ranges or values therebetween. In a preferred embodiment, the present disclosure discloses a method wherein the concentration of hydroxide is about 1 M to about 10 M. In a further preferred embodiment, the present discloses a method wherein the concentration of hydroxide is from about 3 M to about 6 M.

In a further preferred embodiment, the present disclosure discloses a method wherein the concentration of KOH is from about 1 M to about 10 M, or more preferably from about 3 M to about 6 M.

The present disclosed method may be applied to a 2-electrode electrochemical cell. The presently disclosed method may also be applied to a 3-electrode electrochemical cell. In a 3-electrode electrochemical cell, the reference electrode may be a reversible hydrogen electrode (RHE). The electro-reduction of CO₂ may be processed on a three-phase interface at a gas diffusion electrode working as the cathode, where it is reduced to various C₂ products.

The presently disclosed method may be performed at an flow-cell voltage range of at least about 0.5 V, at least about 0.75 V, at least about 0.8 V, at least about 0.93 V, at least about 1 V, at least about 1.1 V, at least about 1.2 V, at least about 1.25 V, at least about 1.3 V, at least about 1.5 V, at least about 1.6 V, at least about 2 V, at least about 2.5 V, at least about 2.6 V, at least about 2.8 V, at least about 3 V, at least about 3.5 V, at least about 4 V, at least about 4.1 V, at least about 4.5 V, at least about 5 V, at least about 5.5 V; or from about 0.5 V to about 5.5 V, from about 0.5 V to about 5 V, from about 0.5 V to about 4.5 V, from about 0.5 V to about 4.1 V, from about 0.5 V to about 4 V, from about 0.5 V to about 3.5 V, from about 0.5 V to about 3 V, from about 0.5 V to about 2.8 V, from about 0.5 V to about 2.6 V, from about 0.5 V to about 2.5 V, from about 0.5 V to about 2 V, from about 0.5 V to about 1.6 V, from about 0.5 V to about 1.5 V, from about 0.5 V to about 1.3 V, from about 0.5 V to about 1.25 V, from about 0.5 V to about 1.2 V, from about 0.5 V to about 1.1 V, from about 0.5 V to about 1 V, from about 0.5 V to about 0.93 V, from about 0.5 V to about 0.8 V, from about 0.5 V to about 0.75 V, from about 0.75 V to about 5.5 V, from about 0.75 V to about 5 V, from about 0.75 V to about 4.5 V, from about 0.75 V to about 4.1 V, from about 0.75 V to about 4 V, from about 0.75 V to about 3.5 V, from about 0.75 V to about 3 V, from about 0.75 V to about 2.8 V, from about 0.75 V to about 2.6 V, from about 0.75 V to about 2.5 V, from about 0.75 V to about 2 V, from about 0.75 V to about 1.6 V, from about 0.75 V to about 1.5 V, from about 0.75 V to about 1.3 V, from about 0.75 V to about 1.25 V, from about 0.75 V to about 1.1 V, from about 0.75 V to about 1 V, from about 0.75 V to about 0.93 V, from about 0.75 V to about 0.8 V, from about 0.8 V to about 5.5 V, from about 0.8 V to about 5 V, from about 0.8 V to about 4.5 V, from about 0.8 V to about 4.1 V, from about 0.8 V to about 4 V, from about 0.8 V to about 3.5 V, from about 0.8 V to about 3 V, from about 0.8 V to about 2.8 V, from about 0.8 V to about 2.6 V, from about 0.8 V to about 2.5 V, from about 0.8 V to about 2 V, from about 0.8 V to about 1.6 V, from about 0.8 V to about 1.5 V, from about 0.8 V to about 1.3 V, from about 0.8 V to about 1.25 V, from about 0.8 V to about 1.2 V, from about 0.8 V to about 1.1 V, from about 0.8 V to about 1 V, from about 0.8 V to about 0.93 V, from about 0.93 V to about 5.5 V, from about 0.93 V to about 5 V, from about 0.93 V to about 4.5 V, from about 0.93 V to about 4.1 V, from about 0.93 V to about 4 V, from about 0.93 V to about 3.5 V, from about 0.93 V to about 3 V, from about 0.93 V to about 2.8 V, from about 0.93 V to about 2.6 V, from about 0.93 V to about 2.5 V, from about 0.93 V to about 2 V, from about 0.93 V to about 1.6 V, from about 0.93 V to about 1.5 V, from about 0.93 V to about 1.3 V, from about 0.93 V to about 1.25 V, from about 0.93 V to about 1.2 V, from about 0.93 V to about 1.1 V, from about 0.93 V to about 1 V, from about 1 V to about 5.5 V, from about 1 V to about 5 V, from about 1 V to about 4.5 V, from about 1 V to about 4.1 V, from about 1 V to about 4 V, from about 1 V to about 3.5 V, from about 1 V to about 3 V, from about 1 V to about 2.8 V, from about 1 V to about 2.6 V, from about 1 V to about 2.5 V, from about 1 V to about 2 V, from about 1 V to about 1.6 V, from about 1 V to about 1.5 V, from about 1 V to about 1.3 V, from about 1 V to about 1.25 V, from about 1 V to about 1.2 V, from about 1 V to about 1.1 V, from about 1.1 V to about 5.5 V, from about 1.1 V to about 5 V, from about 1.1 V to about 4.5 V, from about 1.1 V to about 4.1 V, from about 1.1 V to about 4 V, from about 1.1 V to about 3.5 V, from about 1.1 V to about 3 V, from about 1.1 V to about 2.8 V, from about 1.1 V to about 2.6 V, from about 1.1 V to about 2.5 V, from about 1.1 V to about 2 V, from about 1.1 V to about 1.6 V, from about 1.1 V to about 1.5 V, from about 1.1 V to about 1.3 V, from about 1.1 V to about 1.25 V, from about 1.1 V to about 1.2 V, from about 1.2 V to about 5.5 V, from about 1.2 V to about 5 V, from about 1.2 V to about 4.5 V, from about 1.2 V to about 4.1 V, from about 1.2 V to about 4 V, from about 1.2 V to about 3.5 V, from about 1.2 V to about 3 V, from about 1.2 V to about 2.8 V, from about 1.2 V to about 2.6 V, from about 1.2 V to about 2.5 V, from about 1.2 V to about 2 V, from about 1.2 V to about 1.6 V, from about 1.2 V to about 1.5 V, from about 1.2 V to about 1.3 V, from about 1.2 V to about 1.25 V, from about 1.25 V to about 1.5 V, from about 1.25 V to about 1.3 V, from about 1.3 V to about 5.5 V, from about 1.3 V to about 5 V, from about 1.3 V to about 4.5 V, from about 1.3 V to about 4.1 V, from about 1.3 V to about 4 V, from about 1.3 V to about 3.5 V, from about 1.3 V to about 3 V, from about 1.3 V to about 2.8 V, from about 1.3 V to about 2.6 V, from about 1.3 V to about 2.5 V, from about 1.3 V to about 2 V, from about 1.3 V to about 1.6 V, from about 1.3 V to about 1.5 V, from about 1.5 V to about 5.5 V, from about 1.5 V to about 5 V, from about 1.5 V to about 4.5 V, from about 1.5 V to about 4.1 V, from about 1.5 V to about 4 V, from about 1.5 V to about 3.5 V, from about 1.5 V to about 3 V, from about 1.5 V to about 2.8 V, from about 1.5 V to about 2.6 V, from about 1.5 V to about 2.5 V, from about 1.5 V to about 2 V, from about 1.5 V to about 1.6 V, from about 1.6 V to about 5.5 V, from about 1.6 V to about 5 V, from about 1.6 V to about 4.5 V, from about 1.6 V to about 4.1 V, from about 1.6 V to about 4 V, from about 1.6 V to about 3.5 V, from about 1.6 V to about 3 V, from about 1.6 V to about 2.8 V, from about 1.6 V to about 2.6 V, from about 1.6 V to about 2.5 V, from about 1.6 V to about 2 V, from about 2 V to about 5.5 V, from about 2 V to about 5 V, from about 2 V to about 4.5 V, from about 2 V to about 4.1 V, from about 2 V to about 4 V, from about 2 V to about 3.5 V, from about 2 V to about 3 V, from about 2 V to about 2.8 V, from about 2 V to about 2.6 V, from about 2 V to about 2.5 V, from about 2.5 V to about 5.5 V, from about 2.5 V to about 5 V, from about 2.5 V to about 4.5 V, from about 2.5 V to about 4.1 V, from about 2.5 V to about 4 V, from about 2.5 V to about 3.5 V, from about 2.5 V to about 3 V, from about 2.5 V to about 2.8 V, from about 2.5 V to about 2.6 V, from about 2.6 V to about 5.5 V, from about 2.6 V to about 5 V, from about 2.6 V to about 4.5 V, from about 2.6 V to about 4.1 V, from about 2.6 V to about 4 V, from about 2.6 V to about 3.5 V, from about 2.6 V to about 3 V, from about 2.6 V to about 2.8 V, from about 2.8 V to about 5.5 V, from about 2.8 V to about 5 V, from about 2.8 V to about 4.5 V, from about 2.8 V to about 4.1 V, from about 2.8 V to about 4 V, from about 2.8 V to about 3.5 V, from about 2.8 V to about 3 V, from about 3 V to about 5.5 V, from about 3 V to about 5 V, from about 3 V to about 4.5 V, from about 3 V to about 4.1 V, from about 3 V to about 4 V, from about 3 V to about 3.5 V, from about 3.5 V to about 5.5 V, from about 3.5 V to about 5 V, from about 3.5 V to about 4.5 V, from about 3.5 V to about 4.1 V, from about 3.5 V to about 4 V, from about 4 V to about 5.5 V, from about 4 V to about 5 V, from about 4 V to about 4.5 V, from about 4 V to about 4.1 V, from about 4.1 V to about 5.5 V, from about 4.1 V to about 5 V, from about 4.1 V to about 4.5 V, from about 4.5 V to about 5. V, from about 4.5 V to about 5 V, from about 5 V to about 5.5 V; or at most about 0.5 V, at most about 0.75 V, at most about 0.8 V, at most about 0.93 V, at most about 1 V, at most about 1.1 V, at most about 1.2 V, at most about 1.25 V, at most about 1.3 V, at most about 1.5 V, at most about 1.6 V, at most about 2 V, at most about 2.5 V, at most about 2.6 V, at most about 2.8 V, at most about 3 V, at most about 3.5 V, at most about 4 V, at most about 4.1 V, at most about 4.5 V, at most about 5 V, at most about 5.5 V; or about 0.5 V, about 0.75 V, about 0.8 V, about 0.93 V, about 1 V, about 1.1 V, about 1.2 V, about 1.25 V, about 1.3 V, about 1.5 V, about 1.6 V, about 2 V, about 2.5 V, about 2.6 V, about 2.8 V, about 3 V, about 3.5 V, about 4 V, about 4.1 V, about 4.5 V, about 5 V, about 5.5 V, or any ranges or values therebetween. In a preferred embodiment, the present disclosure discloses a method wherein the voltage is about 1.5 V to about 4.5 V.

The inventors have found that even with a cathode comprising purely carbon paper, the presently disclosed method can surprisingly enrich ¹³CO₂. The inventors have also found that when a cathode with a first base layer of metal nanoparticles and at least 1 layer of carbon nanoparticles are used, the effect is surprisingly improved further. It is believed that the metal nanoparticles improve the conductivity of the electrode surface to facilitate the reduction processes happening at the cathode. Additionally, the metal nanoparticles may also serve as catalysts to catalyst the electro-reduction processes. It is believed that the carbon nanoparticle layers serve to regulate the diffusion of electrolytes, supply current to the water-gas interface, as well as prevent the undesired agglomeration of the metal nanoparticles. The cathode is often found with the metal particle (or catalyst) layer on one side (in contact with the electrolyte), and hydrophobic on the other side (to be in contact with the gaseous feed stream). This allows for a gas-liquid interface to form while preventing the electrolyte from leaking into the feed stream. This is highly advantageous when a liquid electrolyte is used in the electrochemical cell. In a preferred embodiment, the present disclosure discloses a method wherein the electrolyte is a liquid electrolyte.

The support for the cathode may be made of any polymeric porous substrate suitable to provide an interface between the liquid electrolyte and the gas in the feed stream. The support may also comprise any material that is stable in alkaline or highly alkaline liquid electrolytes. In some embodiments, the support for the cathode is selected from the group comprising carbon paper, PTFE paper, PVDF paper, PTFE membrane or PVDF membrane. In a preferred embodiment, the present disclosure discloses a method wherein the cathode is carbon paper. In another preferred embodiment, the present disclosure discloses a method wherein the cathode comprises a support made of carbon paper. In yet another preferred embodiment, the present disclosure discloses a method wherein the polymer of the polymeric porous membrane is PTFE or PVDF.

In some embodiments, the cathode comprises a support layered with a layer of metal nanoparticles. When the support is coated with a first layer of metal nanoparticles, the resulting electrode becomes more highly conductive as a result. However, the surface is often not porous enough to encourage the formation of the gas-liquid interface that is required for the reaction to happen. In the absence of an extensive gas-liquid interface, other side-reactions often dominate as a result. For example, the inventors have found that when the reaction is performed with a cathode comprising only one metal nanoparticle layer, CO₂ electro-reduction was hardly observed, and instead the standard hydrogen evolution reaction dominated.

Hence, by including at least one layer of carbon nanoparticles, a mesoporous network may be formed to both separate the metal nanoparticles, and also allow access of the liquid electrolyte to the gas stream, thus further improving the enrichment effect of the presently disclosed method. The inclusion of a second microparticle layer further stabilises the first two nanoparticle layers, and contributes to the enrichment effect as well. In some other embodiments, the cathode comprises a support layered with a first layer of metal nanoparticles and a second layer of carbon nanoparticles or carbon microparticles. In some further embodiments, the cathode comprises a support layered with a first layer of metal nanoparticles, a second layer of carbon nanoparticles and a third layer of carbon microparticles. In some other embodiments, the cathode comprises a support layered with a first layer of metal nanoparticles, a second layer of carbon nanoparticles and a third layer of carbon microparticles, and wherein the average diameter of the carbon nanoparticles of the second layer is smaller than the average diameter of the carbon microparticles in the third layer. In a preferred embodiment, the present disclosure discloses a method wherein the cathode is carbon paper, or the cathode comprises a support layered with a first layer of metal nanoparticles, a second layer of carbon nanoparticles, and a third layer of carbon microparticles, and wherein the average diameter of the carbon nanoparticles of the second layer is smaller than the average diameter of the carbon nanoparticles in the third layer.

The support must be naturally porous to allow the gas to be in contact with the liquid electrolyte so that the reaction may occur. In some embodiments, the support may comprise a polymeric porous membrane, with a pore size in the range of at least about 0.05 μm, at least about 0.1 μm, at least about 0.3 μm, at least about 0.5 μm, at least about 0.7 μm, at least about 0.8 μm, at least about 1 μm, at least about 1.5 μm, at least about 2 μm, at least about 5 μm; at least about 10 μm; or from about 0.05 μm to about 10 μm, from about 0.05 μm to about 5 μm, from about 0.05 μm to about 2 μm, from about 0.05 μm to about 1.5 μm, from about 0.05 μm to about 1 μm, from about 0.05 μm to about 0.8 μm, from about 0.05 μm to about 0.7 μm, from about 0.05 μm to about 0.5 μm, from about 0.05 μm to about 0.3 μm, from about 0.05 μm to about 0.1 μm, from about 0.1 μm to about 10 μm, from about 0.1 μm to about 5 μm, from about 0.1 μm to about 2 μm, from about 0.1 μm to about 1.5 μm, from about 0.1 μm to about 1 μm, from about 0.1 μm to about 0.8 μm, from about 0.1 μm to about 0.7 μm, from about 0.1 μm to about 0.5 μm, from about 0.1 μm to about 0.3 μm, from about 0.3 μm to about 10 μm, from about 0.3 μm to about 5 μm, from about 0.3 μm to about 2 μm, from about 0.3 μm to about 1.5 μm, from about 0.3 μm to about 1 μm, from about 0.3 μm to about 0.8 μm, from about 0.3 μm to about 0.7 μm, from about 0.3 μm to about 0.5 μm, from about 0.5 μm to about 10 μm, from about 0.5 μm to about 5 μm, from about 0.5 μm to about 2 μm, from about 0.5 μm to about 1.5 μm, from about 0.5 μm to about 1 μm, from about 0.5 μm to about 0.8 μm, from about 0.5 μm to about 0.7 μm, from about 0.7 μm to about 10 μm, from about 0.7 μm to about 5 μm, from about 0.7 μm to about 2 μm, from about 0.7 μm to about 1.5 μm, from about 0.7 μm to about 1 μm, from about 0.7 μm to about 0.8 μm, from about 0.8 μm to about 10 μm, from about 0.8 μm to about 5 μm, from about 0.8 μm to about 2 μm, from about 0.8 μm to about 1.5 μm, from about 0.8 μm to about 1 μm, from about 1 μm to about 10 μm, from about 1 μm to about 5 μm, from about 1 μm to about 2 μm, from about 1 μm to about 1.5 μm, from about 1.5 μm to about 10 μm, from about 1.5 μm to about 5 μm, from about 1.5 μm to about 2 μm, from about 2 μm to about 10 μm, from about 2 μm to about 5 μm, from about 5 μm to about 10 μm; or at most about 0.05 μm, at most about 0.1 μm, at most about 0.3 μm, at most about 0.5 μm, at most about 0.7 μm, at most about 0.8 μm, at most about 1 μm, at most about 1.5 μm, at most about 2 μm, at most about 5 μm; at most about 10 μm; or about 0.05 μm, about 0.1 μm, about 0.3 μm, about 0.5 μm, about 0.7 μm, about 0.8 μm, about 1 μm, about 1.5 μm, about 2 μm, about 5 μm, about 10 μm, or any ranges or values therebetween. In some preferred embodiment, the present disclosure discloses a method wherein the support comprises a polymeric porous membrane with a pore size in the range of about 0.1 μm to about 0.8 μm.

In some embodiments, the carbon nanoparticles may comprise carbon black nanoparticles, graphite nanoparticles, graphite microparticles, graphene nanoparticles, single-walled carbon nanotubes, multi-walled carbon nanotubes, or fullerene nanoparticles. In a preferred embodiment, the present disclosure discloses a method wherein the second layer comprises carbon black nanoparticles, and the third layer comprises graphite microparticles. In another preferred embodiment, the present disclosure discloses a method wherein the second layer comprises graphene nanoparticles and the third layer comprises graphite microparticles.

In some embodiments, the metal nanoparticles may comprise Cu nanoparticles, Ag nanoparticles, Ni nanoparticles, Co nanoparticles, Au nanoparticles, Pd nanoparticles, Pt nanoparticles, Ni nanoparticles, or transition metal nanoparticles. In a preferred embodiment, the present disclosure discloses a method wherein the metal nanoparticles are selected from the group consisting of Cu nanoparticles, Ag nanoparticles, Ni nanoparticles, Co nanoparticles, and Au nanoparticles.

The size of the metal nanoparticles is important in the presently disclosed enrichment process. An overly small nanoparticle size results in over-agglomeration, and are not easy to stabilise as a result. On the other hand, larger-sized metal nanoparticles are more stable, but have a remarkedly lower enrichment effect. In some embodiments, the average diameter of the metal nanoparticles may be in the range of at least about 10 nm, at least about 20 nm, at least about 25 nm, at least about 50 nm, at least about 75 nm, at least about 100 nm, at least about 125 nm, at least about 150 nm, at least about 175 nm, at least about 200 nm, at least about 250 nm, at least about 300 nm, at least about 400 nm, at least about 500 nm; or from about 10 nm to about 500 nm, from about 10 nm to about 400 nm, from about 10 nm to about 300 nm, from about 10 nm to about 250 nm, from about 10 nm to about 200 nm, from about 10 nm to about 175 nm, from about 10 nm to about 150 nm, from about 10 nm to about 125 nm, from about 10 nm to about 100 nm, from about 10 nm to about 75 nm, from about 10 nm to about 50 nm, from about 10 nm to about 25 nm, from about 10 nm to about 20 nm, from about 20 nm to about 500 nm, from about 20 nm to about 400 nm, from about 20 nm to about 300 nm, from about 20 nm to about 250 nm, from about 20 nm to about 200 nm, from about 20 nm to about 175 nm, from about 20 nm to about 150 nm, from about 20 nm to about 125 nm, from about 20 nm to about 100 nm, from about 20 nm to about 75 nm, from about 20 nm to about 50 nm, from about 20 nm to about 25 nm, from about 25 nm to about 500 nm, from about 25 nm to about 400 nm, from about 25 nm to about 300 nm, from about 25 nm to about 250 nm, from about 25 nm to about 200 nm, from about 25 nm to about 175 nm, from about 25 nm to about 150 nm, from about 25 nm to about 125 nm, from about 25 nm to about 100 nm, from about 25 nm to about 75 nm, from about 25 nm to about 50 nm, from about 50 nm to about 500 nm, from about 50 nm to about 400 nm, from about 50 nm to about 300 nm, from about 50 nm to about 250 nm, from about 50 nm to about 200 nm, from about 50 nm to about 175 nm, from about 50 nm to about 150 nm, from about 50 nm to about 125 nm, from about 50 nm to about 100 nm, from about 50 nm to about 75 nm, from about 75 nm to about 500 nm, from about 75 nm to about 400 nm, from about 75 nm to about 300 nm, from about 75 nm to about 250 nm, from about 75 nm to about 200 nm, from about 75 nm to about 175 nm, from about 75 nm to about 150 nm, from about 75 nm to about 125 nm, from about 75 nm to about 100 nm, from about 100 nm to about 500 nm, from about 100 nm to about 400 nm, from about 100 nm to about 300 nm, from about 100 nm to about 250 nm, from about 100 nm to about 200 nm, from about 100 nm to about 175 nm, from about 100 nm to about 150 nm, from about 100 nm to about 125 nm, from about 125 nm to about 500 nm, from about 125 nm to about 400 nm, from about 125 nm to about 300 nm, from about 125 nm to about 250 nm, from about 125 nm to about 200 nm, from about 125 nm to about 175 nm, from about 125 nm to about 150 nm, from about 150 nm to about 500 nm, from about 150 nm to about 400 nm, from about 150 nm to about 300 nm, from about 150 nm to about 250 nm, from about 150 nm to about 200 nm, from about 150 nm to about 175 nm, from about 175 nm to about 500 nm, from about 175 nm to about 400 nm, from about 175 nm to about 300 nm, from about 175 nm to about 250 nm, from about 175 nm to about 200 nm, from about 200 nm to about 500 nm, from about 200 nm to about 400 nm, from about 200 nm to about 300 nm, from about 200 nm to about 250 nm, from about 250 nm to about 500 nm, from about 250 nm to about 400 nm, from about 250 nm to about 300 nm, from about 300 nm to about 500 nm, from about 300 nm to about 400 nm, from about 400 nm to about 500 nm; or at most about 10 nm, at most about 20 nm, at most about 25 nm, at most about 50 nm, at most about 75 nm, at most about 100 nm, at most about 125 nm, at most about 150 nm, at most about 175 nm, at most about 200 nm, at most about 250 nm, at most about 300 nm, at most about 400 nm, at most about 500 nm; or about 10 nm, about 20 nm, about 25 nm, about 50 nm, about 75 nm, about 100 nm, about 125 nm, about 150 nm, about 175 nm, about 200 nm, about 250 nm, about 300 nm, about 400 nm, about 500 nm, or any ranges or values therebetween. In a preferred embodiment, the present disclosure discloses a method wherein the average diameter of the metal nanoparticles is in the range of about 10 nm to about 200 nm. In a further preferred embodiment, the present disclosure discloses a method wherein the average diameter of the metal particles is about 25 nm.

The metal and carbon layers may be formed by spraying the nanoparticle/microparticle dispersions onto the support. The concentration of the metal and/or carbon nanoparticles in the layers formed on the support are affected by a few factors, e.g., the concentration of the nanoparticle dispersion used, the volume of the dispersion sprayed per surface area of the support, and the loss that typically occurs during the spraying process. In some embodiments, the metal nanoparticle (catalyst) loading may be in the range of at least about 0.25 mg/cm², at least about 0.5 mg/cm², at least about 1 mg/cm², at least about 2 mg/cm², at least about 2.5 mg/cm², at least about 4 mg/cm², at least about 5 mg/cm², at least about 7.5 mg/cm², at least about 10 mg/cm², at least about 15 mg/cm²; or from about 0.25 mg/cm² to about 15 mg/cm², from about 0.25 mg/cm² to about 10 mg/cm², from about 0.25 mg/cm² to about 7.5 mg/cm², from about 0.25 mg/cm² to about 5 mg/cm², from about 0.25 mg/cm² to about 4 mg/cm², from about 0.25 mg/cm² to about 2.5 mg/cm², from about 0.25 mg/cm² to about 2 mg/cm², from about 0.25 mg/cm² to about 1 mg/cm², from about 0.25 mg/cm² to about 0.5 mg/cm², from about 0.5 mg/cm² to about 15 mg/cm², from about 0.5 mg/cm² to about 10 mg/cm², from about 0.5 mg/cm² to about 7.5 mg/cm², from about 0.5 mg/cm² to about 5 mg/cm², from about 0.5 mg/cm² to about 4 mg/cm², from about 0.5 mg/cm² to about 2.5 mg/cm², from about 0.5 mg/cm² to about 2 mg/cm², from about 0.5 mg/cm² to about 1 mg/cm², from about 1 mg/cm² to about 15 mg/cm², from about 1 mg/cm² to about 10 mg/cm², from about 1 mg/cm² to about 7.5 mg/cm², from about 1 mg/cm² to about 5 mg/cm², from about 1 mg/cm² to about 4 mg/cm², from about 1 mg/cm² to about 2.5 mg/cm², from about 1 mg/cm² to about 2 mg/cm², from about 2 mg/cm² to about 15 mg/cm², from about 2 mg/cm² to about 10 mg/cm², from about 2 mg/cm² to about 7.5 mg/cm², from about 2 mg/cm² to about 5 mg/cm², from about 2 mg/cm² to about 4 mg/cm², from about 2 mg/cm² to about 2.5 mg/cm², from about 2.5 mg/cm² to about 15 mg/cm², from about 2.5 mg/cm² to about 10 mg/cm², from about 2.5 mg/cm² to about 7.5 mg/cm², from about 2.5 mg/cm² to about 5 mg/cm², from about 2.5 mg/cm² to about 4 mg/cm², from about 4 mg/cm² to about 15 mg/cm², from about 4 mg/cm² to about 10 mg/cm², from about 4 mg/cm² to about 7.5 mg/cm², from about 4 mg/cm² to about 5 mg/cm², from about 5 mg/cm² to about 15 mg/cm², from about 5 mg/cm² to about 10 mg/cm², from about 5 mg/cm² to about 7.5 mg/cm², from about 7.5 mg/cm² to about 15 mg/cm², from about 7.5 mg/cm² to about 10 mg/cm², from about 10 mg/cm² to about 15 mg/cm²; or at most about 0.25 mg/cm², at most about 0.5 mg/cm², at most about 1 mg/cm², at most about 2 mg/cm², at most about 2.5 mg/cm², at most about 4 mg/cm², at most about 5 mg/cm², at most about 7.5 mg/cm², at most about 10 mg/cm², at most about 15 mg/cm²; or about 0.25 mg/cm², about 0.5 mg/cm², about 1 mg/cm², about 2 mg/cm², about 2.5 mg/cm², about 4 mg/cm², about 5 mg/cm², about 7.5 mg/cm², about 10 mg/cm², about 15 mg/cm², or any ranges or values therebetween. In a preferred embodiment, the metal nanoparticle loading and/or the carbon nanoparticle loading is from about 0.5 mg/cm² to about 10 mg/cm², or more preferably from about 1 mg/cm² to about 5 mg/cm². In a preferred embodiment, the catalyst loading is from about 0.5 mg/cm² to about 10 mg/cm², or more preferably from about 1 mg/cm² to about 5 mg/cm². In a further preferred embodiment, the present disclosure discloses a method wherein the metal nanoparticle loading and/or the carbon nanoparticle loading is from about 0.5 mg/cm² to about 4 mg/cm², or about 1 mg/cm² to about 3 mg/cm². In a further preferred embodiment, the present disclosure discloses a method wherein the catalyst loading is from about 0.5 mg/cm² to about 4 mg/cm², or about 1 mg/cm² to about 3 mg/cm². In a further preferred embodiment, the present disclosure discloses a method wherein the concentration of metal nanoparticles is about 0.5 mg/cm² to about 4 mg/cm² of cathode surface area.

In some embodiments, the average diameter of the carbon nanoparticles in the second layer may be in the range of at least about 10 nm, at least about 20 nm, at least about 25 nm, at least about 50 nm, at least about 100 nm, at least about 250 nm, at least about 500 nm, at least about 1000 nm, at least about 1500 nm, at least about 2000 nm, at least about 3000 nm, at least about 4000 nm, at least about 5000 nm; or from about 10 nm to about 5000 nm, from about 10 nm to about 4000 nm, from about 10 nm to about 3000 nm, from about 10 nm to about 2000 nm, from about 10 nm to about 1500 nm, from about 10 nm to about 1000 nm, from about 10 nm to about 500 nm, from about 10 nm to about 250 nm, from about 10 nm to about 100 nm, from about 10 nm to about 50 nm, from about 10 nm to about 25 nm, from about 10 nm to about 20 nm, from about 20 nm to about 5000 nm, from about 20 nm to about 4000 nm, from about 20 nm to about 3000 nm, from about 20 nm to about 2000 nm, from about 20 nm to about 1500 nm, from about 20 nm to about 1000 nm, from about 20 nm to about 500 nm, from about 20 nm to about 250 nm, from about 20 nm to about 100 nm, from about 20 nm to about 50 nm, from about 20 nm to about 25 nm, from about 25 nm to about 5000 nm, from about 25 nm to about 4000 nm, from about 25 nm to about 3000 nm, from about 25 nm to about 2000 nm, from about 25 nm to about 1500 nm, from about 25 nm to about 1000 nm, from about 25 nm to about 500 nm, from about 25 nm to about 250 nm, from about 25 nm to about 100 nm, from about 25 nm to about 50 nm, from about 50 nm to about 5000 nm, from about 50 nm to about 4000 nm, from about 50 nm to about 3000 nm, from about 50 nm to about 2000 nm, from about 50 nm to about 1500 nm, from about 50 nm to about 1000 nm, from about 50 nm to about 500 nm, from about 50 nm to about 250 nm, from about 50 nm to about 100 nm, from about 100 nm to about 5000 nm, from about 100 nm to about 4000 nm, from about 100 nm to about 3000 nm, from about 100 nm to about 2000 nm, from about 100 nm to about 1500 nm, from about 100 nm to about 1000 nm, from about 100 nm to about 500 nm, from about 100 nm to about 250 nm, from about 250 nm to about 5000 nm, from about 250 nm to about 4000 nm, from about 250 nm to about 3000 nm, from about 250 nm to about 2000 nm, from about 250 nm to about 1500 nm, from about 250 nm to about 1000 nm, from about 250 nm to about 500 nm, from about 500 nm to about 5000 nm, from about 500 nm to about 4000 nm, from about 500 nm to about 3000 nm, from about 500 nm to about 2000 nm, from about 500 nm to about 1500 nm, from about 500 nm to about 1000 nm, from about 1000 nm to about 5000 nm, from about 1000 nm to about 4000 nm, from about 1000 nm to about 3000 nm, from about 1000 nm to about 2000 nm, from about 1000 nm to about 1500 nm, from about 1500 nm to about 5000 nm, from about 1500 nm to about 4000 nm, from about 1500 nm to about 3000 nm, from about 1500 nm to about 2000 nm, from about 2000 nm to about 5000 nm, from about 2000 nm to about 4000 nm, from about 2000 nm to about 3000 nm, from about 3000 nm to about 5000 nm, from about 3000 nm to about 4000 nm, from about 4000 nm to about 5000 nm; or at most about 10 nm, at most about 20 nm, at most about 25 nm, at most about 50 nm, at most about 100 nm, at most about 250 nm, at most about 500 nm, at most about 1000 nm, at most about 1500 nm, at most about 2000 nm, at most about 3000 nm, at most about 4000 nm, at about 5000 nm; or about 10 nm, about 20 nm, about 25 nm, about 50 nm, about 100 nm, about 250 nm, about 500 nm, about 1000 nm, about 1500 nm, about 2000 nm, about 3000 nm, about 4000 nm, about 5000 nm, or any ranges values therebetween. In a preferred embodiment, the present disclosure discloses a method wherein the average diameter of the carbon nanoparticles in the second layer is in the range of about 25 nm to about 1,000 nm. In a further preferred embodiment, the present disclosure discloses a method wherein the average diameter of the carbon nanoparticles in the second layer is about 100 nm.

In some embodiments, the average diameter of the carbon microparticles in the third layer may be in the range of at least about 1 μm, at least about 2.5 μm, at least about 4 μm, at least about 5 μm, at least about 7.5 μm, at least about 10 μm, at least about 12.5 μm, at least about 15 μm, at least about 17.5 μm, at least about 20 μm, at least about 30 μm, at least about 40 μm, at least about 50 μm; or from about 1 μm to about 50 μm, from about 1 μm to about 40 μm, from about 1 μm to about 30 μm, from about 1 μm to about 20 μm, from about 1 μm to about 17.5 μm, from about 1 μm to about 15 μm, from about 1 μm to about 12.5 μm, from about 1 μm to about 10 μm, from about 1 μm to about 7.5 μm, from about 1 μm to about 5 μm, from about 1 μm to about 4 μm, from about 1 μm to about 2.5 μm, from about 2.5 μm to about 50 μm, from about 2.5 μm to about 40 μm, from about 2.5 μm to about 30 μm, from about 2.5 μm to about 20 μm, from about 2.5 μm to about 17.5 μm, from about 2.5 μm to about 15 μm, from about 2.5 μm to about 12.5 μm, from about 2.5 μm to about 10 μm, from about 2.5 μm to about 7.5 μm, from about 2.5 μm to about 5 μm, from about 2.5 μm to about 4 μm, from about 4 μm to about 50 μm, from about 4 μm to about 40 μm, from about 4 μm to about 30 μm, from about 4 μm to about 20 μm, from about 4 μm to about 17.5 μm, from about 4 μm to about 15 μm, from about 4 μm to about 12.5 μm, from about 4 μm to about 10 μm, from about 4 μm to about 7.5 μm, from about 4 μm to about 5 μm, from about 5 μm to about 50 μm, from about 5 μm to about 40 μm, from about 5 μm to about 30 μm, from about 5 μm to about 20 μm, from about 5 μm to about 17.5 μm, from about 5 μm to about 15 μm, from about 5 μm to about 12.5 μm, from about 5 μm to about 10 μm, from about 5 μm to about 7.5 μm, from about 7.5 μm to about 50 μm, from about 7.5 μm to about 40 μm, from about 7.5 μm to about 30 μm, from about 7.5 μm to about 20 μm, from about 7.5 μm to about 17.5 μm, from about 7.5 μm to about 15 μm, from about 7.5 μm to about 12.5 μm, from about 7.5 μm to about 10 μm, from about 10 μm to about 50 μm, from about 10 μm to about 40 μm, from about 10 μm to about 30 μm, from about 10 μm to about 20 μm, from about 10 μm to about 17.5 μm, from about 10 μm to about 15 μm, from about 10 μm to about 12.5 μm, from about 12.5 μm to about 50 μm, from about 12.5 μm to about 40 μm, from about 12.5 μm to about 30 μm, from about 12.5 μm to about 20 μm, from about 12.5 μm to about 17.5 μm, from about 12.5 μm to about 15 μm, from about 15 μm to about 50 μm, from about 15 μm to about 40 μm, from about 15 μm to about 30 μm, from about 15 μm to about 20 μm, from about 15 μm to about 17.5 μm, from about 17.5 μm to about 50 μm, from about 17.5 μm to about 40 μm, from about 17.5 μm to about 30 μm, from about 17.5 μm to about 20 μm, from about 20 μm to about 50 μm, from about 20 μm to about 40 μm, from about 20 μm to about 30 μm, from about 30 μm to about 50 μm, from about 30 μm to about 40 μm, from about 40 μm to about 50 μm; or at most about 1 μm, at most about 2.5 μm, at most about 4 μm, at most about 5 μm, at most about 7.5 μm, at most about 10 μm, at most about 12.5 μm, at most about 15 μm, at most about 17.5 μm, at most about 20 μm, at most about 30 μm, at most about 40 μm, at most about 50 μm; or about 1 μm, about 2.5 μm, about 4 μm, about 5 μm, about 7.5 μm, about 10 μm, about 12.5 μm, about 15 μm, about 17.5 μm, about 20 μm, about 30 μm, about 40 μm, about 50 μm, or any ranges or values therebetween. In a preferred embodiment, the present disclosure discloses a method wherein the average diameter of the carbon microparticles in the third layer is in the range of about 4 μm to about 20 μm. In a further preferred embodiment, the present disclosure discloses a method wherein the average diameter of the carbon microparticles in the third layer is in the range of about 5 μm to about 20 μm.

In some embodiments, the average diameter of the carbon microparticles in the third layer may be in the range of at least about 1000 nm, at least about 2500 nm, at least about 4000 nm, at least about 5000 nm, at least about 7500 nm, at least about 10000 nm, at least about 12500 nm, at least about 15000 nm, at least about 17500 nm, at least about 20000 nm, at least about 30000 nm, at least about 40000 nm, at least about 50000 nm; or from about 1000 nm to about 50000 nm, from about 1000 nm to about 40000 nm, from about 1000 nm to about 30000 nm, from about 1000 nm to about 20000 nm, from about 1000 nm to about 17500 nm, from about 1000 nm to about 15000 nm, from about 1000 nm to about 12500 nm, from about 1000 nm to about 10000 nm, from about 1000 nm to about 7500 nm, from about 1000 nm to about 5000 nm, from about 1000 nm to about 4000 nm, from about 1000 nm to about 2500 nm, from about 2500 nm to about 50000 nm, from about 2500 nm to about 40000 nm, from about 2500 nm to about 30000 nm, from about 2500 nm to about 20000 nm, from about 2500 nm to about 17500 nm, from about 2500 nm to about 15000 nm, from about 2500 nm to about 12500 nm, from about 2500 nm to about 10000 nm, from about 2500 nm to about 7500 nm, from about 2500 nm to about 5000 nm, from about 2500 nm to about 4000 nm, from about 4000 nm to about 50000 nm, from about 4000 nm to about 40000 nm, from about 4000 nm to about 30000 nm, from about 4000 nm to about 20000 nm, from about 4000 nm to about 17500 nm, from about 4000 nm to about 15000 nm, from about 4000 nm to about 12500 nm, from about 4000 nm to about 10000 nm, from about 4000 nm to about 7500 nm, from about 4000 nm to about 5000 nm, from about 5000 nm to about 50000 nm, from about 5000 nm to about 40000 nm, from about 5000 nm to about 30000 nm, from about 5000 nm to about 20000 nm, from about 5000 nm to about 17500 nm, from about 5000 nm to about 15000 nm, from about 5000 nm to about 12500 nm, from about 5000 nm to about 10000 nm, from about 5000 nm to about 7500 nm, from about 7500 nm to about 50000 nm, from about 7500 nm to about 40000 nm, from about 7500 nm to about 30000 nm, from about 7500 nm to about 20000 nm, from about 7500 nm to about 17500 nm, from about 7500 nm to about 15000 nm, from about 7500 nm to about 12500 nm, from about 7500 nm to about 10000 nm, from about 10000 nm to about 50000 nm, from about 10000 nm to about 40000 nm, from about 10000 nm to about 30000 nm, from about 10000 nm to about 20000 nm, from about 10000 nm to about 17500 nm, from about 10000 nm to about 15000 nm, from about 10000 nm to about 12500 nm, from about 12500 nm to about 50000 nm, from about 12500 nm to about 40000 nm, from about 12500 nm to about 30000 nm, from about 12500 nm to about 20000 nm, from about 12500 nm to about 17500 nm, from about 12500 nm to about 15000 nm, from about 15000 nm to about 50000 nm, from about 15000 nm to about 40000 nm, from about 15000 nm to about 30000 nm, from about 15000 nm to about 20000 nm, from about 15000 nm to about 17500 nm, from about 17500 nm to about 50000 nm, from about 17500 nm to about 40000 nm, from about 17500 nm to about 30000 nm, from about 17500 nm to about 20000 nm, from about 20000 nm to about 50000 nm, from about 20000 nm to about 40000 nm, from about 20000 nm to about 30000 nm, from about 30000 nm to about 50000 nm, from about 30000 nm to about 40000 nm, from about 40000 nm to about 50000 nm; or at most about 1000 nm, at most about 2500 nm, at most about 4000 nm, at most about 5000 nm, at most about 7500 nm, at most about 10000 nm, at most about 12500 nm, at most about 15000 nm, at most about 17500 nm, at most about 20000 nm, at most about 30000 nm, at most about 40000 nm, at most about 50000 nm; or about 1000 nm, about 2500 nm, about 4000 nm, about 5000 nm, about 7500 nm, about 10000 nm, about 12500 nm, about 15000 nm, about 17500 nm, about 20000 nm, about 30000 nm, about 40000 nm, about 50000 nm, or any ranges or values therebetween. In a preferred embodiment, the present disclosure discloses a method wherein the average diameter of the carbon microparticles in the third layer is in the range of about 4000 nm to about 20000 nm. In a further preferred embodiment, the present disclosure discloses a method wherein the average diameter of the carbon microparticles in the third layer is in the range of about 5000 nm to about 20000 nm.

The anode may comprise materials that are stable in alkaline or highly alkaline liquid electrolytes, such as Ni foam, Ni foam coated with various metal oxide-hydroxides such as FeOOH, NiOOH, or NiCoOₓ(OH)_{y}. In a preferred embodiment, the present disclosure discloses a method wherein the electrochemical cell further comprises an anode, wherein the anode is selected from the group consisting of Ni foam, and Ni foam coated with metal oxide hydroxide. In a further preferred embodiment, the present disclosure discloses a method wherein the Ni foam is coated with metal oxide hydroxide selected from the group consisting of FeOOH, NiOOH, and NiCoOₓ(OH)_{y}.

In a preferred embodiment, the present disclosure discloses a method wherein the cathode is a gas diffusion electrode (GDE).

The electrochemical cell may also comprise an ion-exchange membrane to separate the liquid catholyte from the liquid anolyte, while allowing ions to flow through easily. Examples of suitable ion-exchange membranes may comprise anion exchange membranes, or polymer backbone structures like polysulfone, polyphenol, polyester, PTFE, polypropylene, PVDF, polyester ketone, or mixtures thereof, or polymer backbone structures modified with ion conducting channels formed by tertiary amine groups such as trimethylamine, 1,4-diazabicyclo[2.2.2]octane (DABCO), hexamethylenetetramine, N,N,N,N-tetramethyl-1,6-diaminohexane, or N,N,N,N-tetramethyl-1,2-diaminoethylene or mixtures thereof. In some embodiments, the ion-exchange membrane is a polysulfone-based membrane, preferentially doped with selenium, bromide or similar compounds.

The presently disclosed method may be used in an electrochemical cell comprising a flat membrane cell.

In some embodiments, the unreacted CO₂ may be channeled as a feed stream into either the same cathode chamber, or into the cathode chamber of another reactor. This advantageously allows the same volume of CO₂ to be continuously enriched over multiple cycles. The recirculating process can allow the enrichment of ¹³CO₂ to stack, eventually resulting in a highly enriched ¹³CO₂ stream. The unreacted CO₂ may be directly fed as the feed stream to the cathode chamber, or may first be processed to separate the CO₂ from the liquid products being recirculated as a feed stream to the cathode chamber. In a preferred embodiment, the present disclosure discloses a method wherein the method further comprises recirculating the unreacted CO₂ as a feed stream to the cathode chamber. In a further preferred embodiment, the present disclosure discloses a method wherein the recirculation is performed at least twice. In another preferred embodiment, the present disclosure discloses a method wherein the cathode chamber is a cathode chamber of a different electrochemical cell. In a preferred embodiment, the present disclosure discloses a method further comprising (iv) recirculating the unreacted CO₂ from step (iii) to the cathode chamber. In a further preferred embodiment, the present disclosure discloses a method wherein step (iv) is performed at least twice. In another preferred embodiment, the present disclosure discloses a method wherein the cathode chamber is a cathode chamber of a different electrochemical cell.

In some embodiments, the present disclosure discloses a method wherein the recirculation is performed at least about 1 time, at least about 2 times, at least about 3 times, at least about 4 times, at least about 5 times, at least about 10 times, at least about 20 times, at least about 30 times, at least about 50 times, at least about 100 times, at least about 200 times, at least about 300 times, at least about 500 times, at least about 750 times, at least about 1000 times; or from about 1 time to about 1000 times, from about 1 time to about 750 times, from about 1 time to about 500 times, from about 1 time to about 300 times, from about 1 time to about 200 times, from about 1 time to about 100 times, from about 1 time to about 50 times, from about 1 time to about 30 times, from about 1 time to about 20 times, from about 1 time to about 10 times, from about 1 time to about 5 times, from about 1 time to about 4 times, from about 1 time to about 3 times, from about 1 time to about 2 times, from about 2 times to about 1000 times, from about 2 times to about 750 times, from about 2 times to about 500 times, from about 2 times to about 300 times, from about 2 times to about 200 times, from about 2 times to about 100 times, from about 2 times to about 50 times, from about 2 times to about 30 times, from about 2 times to about 20 times, from about 2 times to about 10 times, from about 2 times to about 5 times, from about 2 times to about 4 times, from about 2 times to about 3 times, from about 3 times to about 1000 times, from about 3 times to about 750 times, from about 3 times to about 500 times, from about 3 times to about 300 times, from about 3 times to about 200 times, from about 3 times to about 100 times, from about 3 times to about 50 times, from about 3 times to about 30 times, from about 3 times to about 20 times, from about 3 times to about 10 times, from about 3 times to about 5 times, from about 3 times to about 4 times, from about 4 times to about 1000 times, from about 4 times to about 750 times, from about 4 times to about 500 times, from about 4 times to about 300 times, from about 4 times to about 200 times, from about 4 times to about 100 times, from about 4 times to about 50 times, from about 4 times to about 30 times, from about 4 times to about 20 times, from about 4 times to about 10 times, from about 4 times to about 5 times, from about 5 times to about 1000 times, from about 5 times to about 750 times, from about 5 times to about 500 times, from about 5 times to about 300 times, from about 5 times to about 200 times, from about 5 times to about 100 times, from about 5 times to about 50 times, from about 5 times to about 30 times, from about 5 times to about 20 times, from about 5 times to about 10 times, from about 10 times to about 1000 times, from about 10 times to about 750 times, from about 10 times to about 500 times, from about 10 times to about 300 times, from about 10 times to about 200 times, from about 10 times to about 100 times, from about 10 times to about 50 times, from about 10 times to about 30 times, from about 10 times to about 20 times, from about 20 times to about 1000 times, from about 20 times to about 750 times, from about 20 times to about 500 times, from about 20 times to about 300 times, from about 20 times to about 200 times, from about 20 times to about 100 times, from about 20 times to about 50 times, from about 20 times to about 30 times, from about 30 times to about 1000 times, from about 30 times to about 750 times, from about 30 times to about 500 times, from about 30 times to about 300 times, from about 30 times to about 200 times, from about 30 times to about 100 times, from about 30 times to about 50 times, from about 30 times to about 40 times, from about 40 times to about 1000 times, from about 40 times to about 750 times, from about 40 times to about 500 times, from about 40 times to about 300 times, from about 40 times to about 200 times, from about 40 times to about 100 times, from about 40 times to about 50 times, from about 50 times to about 1000 times, from about 50 times to about 750 times, from about 50 times to about 500 times, from about 50 times to about 300 times, from about 50 times to about 200 times, from about 50 times to about 100 times, from about 100 times to about 1000 times, from about 100 times to about 750 times, from about 100 times to about 500 times, from about 100 times to about 300 times, from about 100 times to about 200 times, from about 200 times to about 1000 times, from about 200 times to about 750 times, from about 200 times to about 500 times, from about 200 times to about 300 times, from about 300 times to about 1000 times, from about 300 times to about 750 times, from about 300 times to about 500 times, from about 500 times to about 1000 times, from about 500 times to about 750 times, from about 750 times to about 1000 times; or at most about 1 time, at most about 2 times, at most about 3 times, at most about 4 times, at most about 5 times, at most about 10 times, at most about 20 times, at most about 30 times, at most about 50 times, at most about 100 times, at most about 200 times, at most about 300 times, at most about 500 times, at most about 750 times, at most about 1000 times; or about 1 time, about 2 times, about 3 times, about 4 times, about 5 times, about 10 times, about 20 times, about 30 times, about 50 times, about 100 times, about 200 times, about 300 times, about 500 times, about 750 times, about 1000 times, or any ranges or values therebetween. In a preferred embodiment, the present disclosure discloses a method wherein the recirculation is performed at least twice.

The presently disclosed method can produce a highly enriched ¹³CO₂ stream. The presently disclosed method is also capable of producing one or more product streams comprising reduction products, like carbon monoxide, ethanol, ethane, ethene, acetic acid, among others. In a preferred embodiment, the present disclosure discloses ¹³CO₂ produced by the method disclosed herein. In a further preferred embodiment, the present disclosure discloses a product produced by the method disclosed herein, wherein the product comprises ethanol, ethane, ethene and acetic acid. In another preferred embodiment, the present disclosure discloses a product produced by the method disclosed herein, wherein the product comprises CO, ethylene, propene and ethanol. In a further preferred embodiment, the present disclosure discloses a product produced by the method disclosed herein, wherein the product is selected from the group consisting of ethylene, ethanol, and acetic acid.

The presently disclosed method can produce a highly enriched ¹³CO₂ stream. The presently disclosed method is also capable of producing one or more product streams comprising reduction products, like formic acid, methane, acetone, propyl aldehyde, propylene and propanol, amongst others. The present disclosed method can also produce various reduction products like syngas, CO and H₂. In some other embodiments, the presently disclosed method is capable of producing C₂ products comprising ethanol, ethane, ethene, acetic acid or acetaldehyde. In other embodiments, the presently disclosed method is capable of producing products comprising formic acid, methane, acetone, propyl aldehyde, propylene, propanol, CO, H₂, C₂ products comprising ethanol, ethane, ethene, acetic acid, or acetaldehyde. In a preferred embodiment, the present disclosure discloses ¹³CO₂ produced by the method disclosed herein. In a further preferred embodiment, the present disclosure discloses a product produced by the method disclosed herein, wherein the product comprises CO, H₂, formic acid, methane, ethanol, ethane, ethene, acetic acid, acetaldehyde, acetone, propyl aldehyde, propylene and propanol. In another preferred embodiment, the present disclosure discloses CO, ethylene, propene and ethanol mainly produced by the method disclosed herein. In another preferred embodiment, the present disclosure discloses CO, ethylene, propene and ethanol produced by the method disclosed herein. In a further preferred embodiment, the present disclosure discloses CO mainly produced by the method disclosed herein. In a further preferred embodiment, the present disclosure discloses CO produced by the method disclosed herein.

In some embodiments, the presently disclosed method can reduce a portion of CO₂ in the feed stream to products, in a range of at least about 0.5%, at least about 0.68%, at least about 0.7%, at least about 1%, at least about 2%, at least about 2.2%, at least about 2.64%, at least about 2.78%, at least about 3.51%, at least about 5%, at least about 8%, at least about 10%, at least about 12%, at least about 20%, at least about 25%, at least about 28%, at least about 31%, at least about 35%, at least about 40%, at least about 50% at least about 70%, at least about 90%; or from about 0.5% to about 90%, from about 0.5% to about 70%, from about 0.5% to about 50%, from about 0.5% to about 40%, from about 0.5% to about 35%, from about 0.5% to about 31%, from about 0.5% to about 28%, from about 0.5% to about 25%, from about 0.5% to about 20%, from about 0.5% to about 12%, from about 0.5% to about 10%, from about 0.5% to about 8%, from about 0.5% to about 5%, from about 0.5% to about 3.51%, from about 0.5% to about 2.78%, from about 0.5% to about 2.64%, from about 0.5% to about 2.2%, from about 0.5% to about 2%, from about 0.5% to about 1%, from about 0.5% to about 0.7%, from about 0.5% to about 0.68%, from about 0.68% to about 90%, from about 0.68% to about 70%, from about 0.68% to about 50%, from about 0.68% to about 40%, from about 0.68% to about 31%, from about 0.68% to about 28%, from about 0.68% to about 25%, from about 0.68% to about 20%, from about 0.68% to about 12%, from about 0.68% to about 10%, from about 0.68% to about 8%, from about 0.68% to about 5%, from about 0.68% to about 3.51%, from about 0.68% to about 2.78%, from about 0.68% to about 2.64%, from about 0.68% to about 2.2%, from about 0.68% to about 2%, from about 0.68% to about 1%, from about 0.68% to about 0.7%, from about 0.7% to about 90%, from about 0.7% to about 70%, from about 0.7% to about 50%, from about 0.7% to about 40%, from about 0.7% to about 31%, from about 0.7% to about 28%, from about 0.7% to about 25%, from about 0.7% to about 20%, from about 0.7% to about 12%, from about 0.7% to about 10%, from about 0.7% to about 8%, from about 0.7% to about 5%, from about 0.7% to about 3.51%, from about 0.7% to about 2.78%, from about 0.7% to about 2.64%, from about 0.7% to about 2.2%, from about 0.7% to about 2%, from about 0.7% to about 1%, from about 1% to about 90%, from about 1% to about 70%, from about 1% to about 50%, from about 1% to about 40%, from about 1% to about 31%, from about 1% to about 28%, from about 1% to about 25%, from about 1% to about 20%, from about 1% to about 12%, from about 1% to about 10%, from about 1% to about 8%, from about 1% to about 5%, from about 1% to about 3.51%, from about 1% to about 2.78%, from about 1% to about 2.64%, from about 1% to about 2.2%, from about 1% to about 2%, from about 2% to about 90%, from about 2% to about 70%, from about 2% to about 50%, from about 2% to about 40%, from about 2% to about 31%, from about 2% to about 28%, from about 2% to about 25%, from about 2% to about 20%, from about 2% to about 12%, from about 2% to about 10%, from about 2% to about 8%, from about 2% to about 5%, from about 2% to about 3.51%, from about 2% to about 2.78%, from about 2% to about 2.64%, from about 2% to about 2.2%, from about 2.2% to about 90%, from about 2.2% to about 70%, from about 2.2% to about 50%, from about 2.2% to about 40%, from about 2.2% to about 31%, from about 2.2% to about 28%, from about 2.2% to about 25%, from about 2.2% to about 20%, from about 2.2% to about 12%, from about 2.2% to about 10%, from about 2.2% to about 8%, from about 2.2% to about 5%, from about 2.2% to about 3.51%, from about 2.2% to about 2.78%, from about 2.2% to about 2.64%, from about 2.64% to about 90%, from about 2.64% to about 70%, from about 2.64% to about 50%, from about 2.64% to about 40%, from about 2.64% to about 31%, from about 2.64% to about 28%, from about 2.64% to about 25%, from about 2.64% to about 20%, from about 2.64% to about 12%, from about 2.64% to about 10%, from about 2.64% to about 8%, from about 2.64% to about 5%, from about 2.64% to about 3.51%, from about 2.64% to about 2.78%, from about 2.78% to about 90%, from about 2.78% to about 70%, from about 2.78% to about 50%, from about 2.78% to about 40%, from about 2.78% to about 31%, from about 2.78% to about 28%, from about 2.78% to about 25%, from about 2.78% to about 20%, from about 2.78% to about 12%, from about 2.78% to about 10%, from about 2.78% to about 8%, from about 2.78% to about 5%, from about 2.78% to about 3.51%, from about 3.51% to about 90%, from about 3.51% to about 70%, from about 3.51% to about 50%, from about 3.51% to about 40%, from about 3.51% to about 31%, from about 3.51% to about 28%, from about 3.51% to about 25%, from about 3.51% to about 20%, from about 3.51% to about 12%, from about 3.51% to about 10%, from about 3.51% to about 8%, from about 3.51% to about 5%, from about 5% to about 90%, from about 5% to about 70%, from about 5% to about 50%, from about 5% to about 40%, from about 5% to about 31%, from about 5% to about 28%, from about 5% to about 25%, from about 5% to about 20%, from about 5% to about 12%, from about 5% to about 10%, from about 5% to about 8%, from about 8% to about 90%, from about 8% to about 70%, from about 8% to about 50%, from about 8% to about 40%, from about 8% to about 31%, from about 8% to about 28%, from about 8% to about 25%, from about 8% to about 20%, from about 8% to about 12%, from about 8% to about 10%, from about 10% to about 90%, from about 10% to about 70%, from about 10% to about 50%, from about 10% to about 40%, from about 10% to about 31%, from about 10% to about 28%, from about 10% to about 25%, from about 10% to about 20%, from about 10% to about 12%, from about 12% to about 90%, from about 12% to about 70%, from about 12% to about 50%, from about 12% to about 40%, from about 12% to about 31%, from about 12% to about 28%, from about 12% to about 25%, from about 12% to about 20%, from about 20% to about 90%, from about 20% to about 70%, from about 20% to about 50%, from about 20% to about 40%, from about 20% to about 31%, from about 20% to about 28%, from about 20% to about 25%, from about 25% to about 90%, from about 25% to about 70%, from about 25% to about 50%, from about 25% to about 40%, from about 25% to about 31%, from about 25% to about 28%, from about 28% to about 50%, from about 28% to about 40%, from about 28% to about 31%, from about 31% to about 50%, from about 31% to about 40%, from about 40% to about 90%, from about 40% to about 70%, from about 40% to about 50%, from about 50% to about 90%, from about 50% to about 70%, from about 70% to about 90%; or at most about 0.5%, at most about 0.68%, at most about 0.7%, at most about 1%, at most about 2%, at most about 2.2%, at most about 2.64%, at most about 2.78%, at most about 3.51%, at most about 5%, at most about 8%, at most about 10%, at most about 12%, at most about 20%, at most about 25%, at most about 28%, at most about 31%, at most about 40%, at most about 50%, at most about 70%, at most about 90%; or about 0.5%, about 0.68%, about 0.7%, about 1%, about 2%, about 2.2%, about 2.64%, about 2.78%, about 3.51%, about 5%, about 8%, about 10%, about 12%, about 20%, about 25%, about 28%, about 31%, about 35%, about 40%, about 50%, about 70%, about 90%, or any ranges or values therebetween. In a preferred embodiment, the present disclosure discloses a method wherein about 5% to about 35% of CO₂ in the feed stream is converted to one or more products. In a further preferred embodiment, the present disclosure discloses a method wherein about 5% to about 35% of CO₂ in the feed stream is converted to one or more products, wherein the product is selected from the group consisting of ethylene, ethanol, and acetic acid.

In some embodiments, the unreacted CO₂ may have a ¹³C isotope concentration in the range of at least about 1.112%, at least about 1.114%, at least about 1.115%, at least about 1.119%, at least about 1.12%, at least about 1.121%, at least about 1.124%, at least about 1.125%, at least about 1.13%, at least about 1.15%, at least about 1.23%, at least about 1.27%, at least about 1.47%, at least about 2.5%, at least about 5.76%, at least about 10%, at least about 30%, at least about 50%, at least about 70%, at least about 88.7%, at least about 90%, at least about 95%, at least about 99%, at least about 99.9%, at least about 99.99%; or from about 1.112% to about 99.99%, from about 1.112% to about 99.9%, from about 1.112% to about 99%, from about 1.112% to about 95%, from about 1.112% to about 90%, from about 1.112% to about 88.7%, from about 1.112% to about 70%, from about 1.112% to about 50%, from about 1.112% to about 30%, from about 1.112% to about 10%, from about 1.112% to about 5.76%, from about 1.112% to about 2.5%, from about 1.112% to about 1.47%, from about 1.112% to about 1.27%, from about 1.112% to about 1.23%, from about 1.112% to about 1.15%, from about 1.112% to about 1.13%, from about 1.112% to about 1.125%, from about 1.112% to about 1.124%, from about 1.112% to about 1.121%, from about 1.112% to about 1.12%, from about 1.112% to about 1.119%, from about 1.112% to about 1.115%, from about 1.112% to about 1.114%, from about 1.114% to about 99.99%, from about 1.114% to about 99.9%, from about 1.114% to about 99%, from about 1.114% to about 95%, from about 1.114% to about 90%, from about 1.114% to about 88.7%, from about 1.114% to about 70%, from about 1.114% to about 50%, from about 1.114% to about 30%, from about 1.114% to about 10%, from about 1.114% to about 5.76%, from about 1.114% to about 2.5%, from about 1.114% to about 1.47%, from about 1.114% to about 1.27%, from about 1.114% to about 1.23%, from about 1.114% to about 1.15%, from about 1.114% to about 1.13%, from about 1.114% to about 1.125%, from about 1.114% to about 1.124%, from about 1.114% to about 1.121%, from about 1.114% to about 1.12%, from about 1.114% to about 1.119%, from about 1.114% to about 1.115%, from about 1.115% to about 99.99%, from about 1.115% to about 99.9%, from about 1.115% to about 99%, from about 1.115% to about 95%, from about 1.115% to about 90%, from about 1.115% to about 88.7%, from about 1.115% to about 70%, from about 1.115% to about 50%, from about 1.115% to about 30%, from about 1.115% to about 10%, from about 1.115% to about 5.76%, from about 1.115% to about 2.5%, from about 1.115% to about 1.47%, from about 1.115% to about 1.27%, from about 1.115% to about 1.23%, from about 1.115% to about 1.15%, from about 1.115% to about 1.13%, from about 1.115% to about 1.125%, from about 1.115% to about 1.124%, from about 1.115% to about 1.121%, from about 1.115% to about 1.12%, from about 1.115% to about 1.119%, from about 1.119% to about 99.99%, from about 1.119% to about 99.9%, from about 1.119% to about 99%, from about 1.119% to about 95%, from about 1.119% to about 90%, from about 1.119% to about 88.7%, from about 1.119% to about 70%, from about 1.119% to about 50%, from about 1.119% to about 30%, from about 1.119% to about 10%, from about 1.119% to about 5.76%, from about 1.119% to about 2.5%, from about 1.119% to about 1.47%, from about 1.119% to about 1.27%, from about 1.119% to about 1.23%, from about 1.119% to about 1.15%, from about 1.119% to about 1.13%, from about 1.119% to about 1.125%, from about 1.119% to about 1.124%, from about 1.119% to about 1.121%, from about 1.119% to about 1.12%, from about 1.12% to about 99.99%, from about 1.12% to about 99.9%, from about 1.12% to about 99%, from about 1.12% to about 95%, from about 1.12% to about 90%, from about 1.12% to about 88.7%, from about 1.12% to about 70%, from about 1.12% to about 50%, from about 1.12% to about 30%, from about 1.12% to about 10%, from about 1.12% to about 5.76%, from about 1.12% to about 2.5%, from about 1.12% to about 1.47%, from about 1.12% to about 1.27%, from about 1.12% to about 1.23%, from about 1.12% to about 1.15%, from about 1.12% to about 1.13%, from about 1.12% to about 1.125%, from about 1.12% to about 1.124%, from about 1.12% to about 1.121%, from about 1.121% to about 99.99%, from about 1.121% to about 99.9%, from about 1.121% to about 99%, from about 1.121% to about 95%, from about 1.121% to about 90%, from about 1.121% to about 88.7%, from about 1.121% to about 70%, from about 1.121% to about 50%, from about 1.121% to about 30%, from about 1.121% to about 10%, from about 1.121% to about 5.76%, from about 1.121% to about 2.5%, from about 1.121% to about 1.47%, from about 1.121% to about 1.27%, from about 1.121% to about 1.23%, from about 1.121% to about 1.15%, from about 1.121% to about 1.13%, from about 1.121% to about 1.125%, from about 1.121% to about 1.124%, from about 1.124% to about 99.99%, from about 1.124% to about 99.9%, from about 1.124% to about 99%, from about 1.124% to about 95%, from about 1.124% to about 90%, from about 1.124% to about 88.7%, from about 1.124% to about 70%, from about 1.124% to about 50%, from about 1.124% to about 30%, from about 1.124% to about 10%, from about 1.124% to about 5.76%, from about 1.124% to about 2.5%, from about 1.124% to about 1.47%, from about 1.124% to about 1.27%, from about 1.124% to about 1.23%, from about 1.124% to about 1.15%, from about 1.124% to about 1.13%, from about 1.124% to about 1.125%, from about 1.125% to about 99.99%, from about 1.125% to about 99.9%, from about 1.125% to about 99%, from about 1.125% to about 95%, from about 1.125% to about 90%, from about 1.125% to about 88.7%, from about 1.125% to about 70%, from about 1.125% to about 50%, from about 1.125% to about 30%, from about 1.125% to about 10%, from about 1.125% to about 5.76%, from about 1.125% to about 2.5%, from about 1.125% to about 1.47%, from about 1.125% to about 1.27%, from about 1.125% to about 1.23%, from about 1.125% to about 1.15%, from about 1.125% to about 1.13%, from about 1.13% to about 99.99%, from about 1.13% to about 99.9%, from about 1.13% to about 99%, from about 1.13% to about 95%, from about 1.13% to about 90%, from about 1.13% to about 88.7%, from about 1.13% to about 70%, from about 1.13% to about 50%, from about 1.13% to about 30%, from about 1.13% to about 10%, from about 1.13% to about 5.76%, from about 1.13% to about 2.5%, from about 1.13% to about 1.47%, from about 1.13% to about 1.27%, from about 1.13% to about 1.23%, from about 1.13% to about 1.15%, from about 1.15% to about 99.99%, from about 1.15% to about 99.9%, from about 1.15% to about 99%, from about 1.15% to about 95%, from about 1.15% to about 90%, from about 1.15% to about 88.7%, from about 1.15% to about 70%, from about 1.15% to about 50%, from about 1.15% to about 30%, from about 1.15% to about 10%, from about 1.15% to about 2.76%, from about 1.15% to about 2.5%, from about 1.15% to about 1.47%, from about 1.15% to about 1.27%, from about 1.15% to about 1.23%, from about 1.23% to about 99.99%, from about 1.23% to about 99.9%, from about 1.23% to about 99%, from about 1.23% to about 95%, from about 1.23% to about 90%, from about 1.23% to about 88.7%, from about 1.23% to about 70%, from about 1.23% to about 50%, from about 1.23% to about 30%, from about 1.23% to about 10%, from about 1.23% to about 5.76%, from about 1.23% to about 2.5%, from about 1.23% to about 1.47%, from about 1.23% to about 1.27%, from about 1.27% to about 99.99%, from about 1.27% to about 99.9%, from about 1.27% to about 99%, from about 1.27% to about 95%, from about 1.27% to about 90%, from about 1.27% to about 88.7%, from about 1.27% to about 70%, from about 1.27% to about 50%, from about 1.27% to about 30%, from about 1.27% to about 10%, from about 1.27% to about 5.76%, from about 1.27% to about 2.5%, from about 1.27% to about 1.47%, from about 1.47% to about 99.99%, from about 1.47% to about 99.9%, from about 1.47% to about 99%, from about 1.47% to about 95%, from about 1.47% to about 90%, from about 1.47% to about 88.7%, from about 1.47% to about 70%, from about 1.47% to about 50%, from about 1.47% to about 30%, from about 1.47% to about 10%, from about 1.47% to about 5.76%, from about 1.47% to about 2.5%, from about 2.5% to about 99.99%, from about 2.5% to about 99.9%, from about 2.5% to about 99%, from about 2.5% to about 95%, from about 2.5% to about 90%, from about 2.5% to about 88.7%, from about 2.5% to about 70%, from about 2.5% to about 50%, from about 2.5% to about 30%, from about 2.5% to about 10%, from about 2.5% to about 5.76%, from about 5.76% to about 99.99%, from about 5.76% to about 99.9%, from about 5.76% to about 99%, from about 5.76% to about 95%, from about 5.76% to about 90%, from about 5.76% to about 88.7%, from about 5.76% to about 70%, from about 5.76% to about 50%, from about 5.76% to about 30%, from about 5.76% to about 10%, from about 10% to about 99.99%, from about 10% to about 99.9%, from about 10% to about 99%, from about 10% to about 95%, from about 10% to about 90%, from about 10% to about 88.7%, from about 10% to about 70%, from about 10% to about 50%, from about 10% to about 30%, from about 30% to about 99.99%, from about 30% to about 99.9%, from about 30% to about 99%, from about 30% to about 95%, from about 30% to about 90%, from about 30% to about 88.7%, from about 30% to about 70%, from about 30% to about 50%, from about 50% to about 99.99%, from about 50% to about 99.9%, from about 50% to about 99%, from about 50% to about 95%, from about 50% to about 90%, from about 50% to about 88.7%, from about 50% to about 70%, from about 70% to about 99.99%, from about 70% to about 99.9%, from about 70% to about 99%, from about 70% to about 95%, from about 70% to about 90%, from about 70% to about 88.7%, from about 88.7% to about 99.99%, from about 88.7% to about 99.9%, from about 88.7% to about 99%, from about 88.7% to about 95%, from about 88.7% to about 90%, from about 90% to about 99.99%, from about 90% to about 99.9%, from about 90% to about 99%, from about 90% to about 95%, from about 95% to about 99.99%, from about 95% to about 99.9%, from about 95% to about 99%, from about 99% to about 99.99%, from about 99% to about 99.9%, from about 99.9% to about 99.99%; or at most about 1.112%, at most about 1.114%, at most about 1.115%, at most about 1.119%, at most about 1.12%, at most about 1.121%, at most about 1.124%, at most about 1.125%, at most about 1.13%, at most about 1.15%, at most about 1.23%, at most about 1.27%, at most about 1.47%, at most about 2.5%, at most about 5.76%, at most about 10%, at most about 30%, at most about 50%, at most about 70%, at most about 88.7%, at most about 90%, at most about 95%, at most about 99%, at most about 99.9%, at most about 99.99%; or about 1.112%, about 1.114%, about 1.115%, about 1.119%, about 1.12%, about 1.121%, about 1.124%, about 1.125%, about 1.13%, about 1.15%, about 1.23%, about 1.27%, about 1.47%, about 2.5%, about 5.76%, about 10%, about 30%, about 50%, about 70%, about 88.7%, about 90%, about 95%, about 99%, about 99.9%, about 99.99%; or any ranges or values therebetween.

In some other embodiments the unreacted CO₂ may be further enriched in ¹³C relative to the feed stream, having a δ¹³C in a range of at least about 4%, wherein

$${δ}^{13} C = ( \frac{{{(}^{13} C {/}^{12} C )}_{sample}}{{{(}^{13} C {/}^{12} C )}_{standard}} - 1 ) \times 1000 \%$$

wherein (¹³C/¹²C)ₛₐₘₚₗₑ is measured isotopes ratio after reaction and (¹³C/¹²C)_{standard} is initial isotopes ratio before reaction.

δ¹³C may be at least about 4%, at least about 6%, at least about 6.76%, at least about 10.5%, at least about 11.33%, at least about 12%, at least about 14.8%, at least about 16%, at least about 18.22%, at least about 22%, at least about 34.23%, at least about 36.46%, at least about 50%, at least about 109.45%, at least about 146%, at least about 200%, at least about 329.16%, at least about 400%, at least about 500%; or from about 4% to about 500%, from about 4% to about 400%, from about 4% to about 329.16%, from about 4% to about 200%, from about 4% to about 146%, from about 4% to about 109.45%, from about 4% to about 50%, from about 4% to about 36.46%, from about 4% to about 34.23%, from about 4% to about 22%, from about 4% to about 18.22%, from about 4% to about 16%, from about 4% to about 14.8%, from about 4% to about 12%, from about 4% to about 11.33%, from about 4% to about 10.5%, from about 4% to about 6.76%, from about 4% to about 6%, from about 6% to about 500%, from about 6% to about 400%, from about 6% to about 329.16%, from about 6% to about 200%, from about 6% to about 146%, from about 6% to about 109.45%, from about 6% to about 50%, from about 6% to about 36.46%, from about 6% to about 34.23%, from about 6% to about 22%, from about 6% to about 18.22%, from about 6% to about 16%, from about 6% to about 14.8%, from about 6% to about 12%, from about 6% to about 11.33%, from about 6% to about 10.5%, from about 6% to about 6.76%, from about 6.76% to about 500%, from about 6.76% to about 400%, from about 6.76% to about 329.16%, from about 6.76% to about 200%, from about 6.76% to about 146%, from about 6.76% to about 109.45%, from about 6.76% to about 50%, from about 6.76% to about 36.46%, from about 6.76% to about 34.23%, from about 6.76% to about 22%, from about 6.76% to about 18.22%, from about 6.76% to about 16%, from about 6.76% to about 14.8%, from about 6.76% to about 12%, from about 6.76% to about 11.330%, from about 6.76% to about 10.5%, from about 10.5% to about 500%, from about 10.5% to about 400%, from about 10.5% to about 329.16%, from about 10.5% to about 200%, from about 10.5% to about 146%, from about 10.5% to about 109.45%, from about 10.5% to about 50%, from about 10.5% to about 36.46%, from about 10.5% to about 34.23%, from about 10.5% to about 22%, from about 10.5% to about 18.22%, from about 10.5% to about 16%, from about 10.5% to about 14.8%, from about 10.5% to about 12%, from about 10.5% to about 11.33%, from about 11.33% to about 500%, from about 11.33% to about 400%, from about 11.33% to about 329.16%, from about 11.33% to about 200%, from about 11.33% to about 146%, from about 11.33% to about 109.45%, from about 11.33% to about 50%, from about 11.33% to about 36.46%, from about 11.33% to about 34.23%, from about 11.33% to about 22%, from about 11.33% to about 18.22%, from about 11.33% to about 16%, from about 11.33% to about 14.8%, from about 11.33% to about 12%, from about 12% to about 500%, from about 12% to about 400%, from about 12% to about 329.16%, from about 12% to about 200%, from about 12% to about 146%, from about 12% to about 109.45%, from about 12% to about 50%, from about 12% to about 36.46%, from about 12% to about 34.23%, from about 12% to about 22%, from about 12% to about 18.22%, from about 12% to about 16%, from about 12% to about 14.8%, from about 14.8% to about 500%, from about 14.8% to about 400%, from about 14.8% to about 329.16%, from about 14.8% to about 200%, from about 14.8% to about 146%, from about 14.8% to about 109.45%, from about 14.8% to about 50%, from about 14.8% to about 36.46%, from about 14.8% to about 34.23%, from about 14.8% to about 22%, from about 140.8% to about 18.22%, from about 14.8% to about 16%, from about 16% to about 500%, from about 16% to about 400%, from about 16% to about 329.16%, from about 16% to about 200%, from about 16% to about 146%, from about 16% to about 109.45%, from about 16% to about 50%, from about 16% to about 36.46%, from about 16% to about 34.23%, from about 16% to about 22%, from about 16% to about 18.22%, from about 18.22% to about 500%, from about 180.22% to about 400%, from about 180.22% to about 329.16%, from about 18.22% to about 200%, from about 18.22% to about 146%, from about 18.22% to about 109.45%, from about 18.22% to about 50%, from about 18.22% to about 36.46%, from about 18.22% to about 34.23%, from about 18.22% to about 22%, from about 22% to about 500%, from about 22% to about 400%, from about 22% to about 329.16%, from about 22% to about 200%, from about 22% to about 146%, from about 22% to about 109.45%, from about 22% to about 50%, from about 22% to about 36.46%, from about 22% to about 34.23%, from about 34.23% to about 500%, from about 34.23% to about 400%, from about 34.23% to about 329.16%, from about 34.23% to about 200%, from about 34.23% to about 146%, from about 340.23% to about 109.45%, from about 34.23% to about 50%, from about 34.23% to about 36.46%, from about 36.46% to about 500%, from about 36.46% to about 400%, from about 36.46% to about 329.16%, from about 36.46% to about 200%, from about 36.46% to about 146%, from about 36.46% to about 109.45%, from about 36.46% to about 50%, from about 50% to about 500%, from about 50% to about 400%, from about 50% to about 329.16%, from about 50% to about 200%, from about 50% to about 146%, from about 50% to about 109.45%, from about 109.45% to about 500%, from about 109.45% to about 400%, from about 109.45% to about 329.16%, from about 109.45% to about 200%, from about 109.45% to about 146%, from about 146% to about 500%, from about 146% to about 400%, from about 146% to about 329.16%, from about 146% to about 200%, from about 1090.45% to about 146%, from about 200% to about 500%, from about 200% to about 400%, from about 200% to about 329.16%, from about 329.16% to about 500%, from about 329.16% to about 400%, from about 400% to about 400%; or at most about 4%, at most about 6%, at most about 6.76%, at most about 10.5%, at most about 11.33%, at most about 12%, at most about 14.8%, at most about 16%, at most about 18.22%, at most about 22%, at most about 34.23%, at most about 36.46%, at most about 50%, at most about 109.45%, at most about 146%, at most about 200%, at most about 329.16%, at most about 400%, at most about 500%; or about 4%, about 6%, about 6.76%, about 10.5%, about 11.33%, about 12%, about 14.8%, about 16%, about 18.22%, about 22%, about 34.23%, about 36.46%, about 50%, about 109.45%, about 146%, about 200%, about 329.16%, about 400%, about 500%, or any ranges or values therebetween.

In some other embodiments the unreacted CO₂ may be further enriched in ¹³C relative to the feed stream, having a Δ¹³C in a range of at least about 0.001%, wherein:

$${Δ}^{13} C ( \% ) = x {(}^{13} {C}_{o u t l e t} ) ( \% ) - x {(}^{13} {C}_{feed} ) ( \% )$$

$$wherein$$

$$x {(}^{13} {C}_{c o n t e n t} ) ( \% ) = \frac{n {(}^{13} {CO}_{2} )}{n {(}^{13} {CO}_{2} ) + n {(}^{12} {CO}_{2} )} * 1 \; 00 \% ;$$

n represents molar amount;
x(¹³C_{feed}) represents molar fraction of ¹³CO₂ in the CO₂ in the feed stream;
x(¹³Cₒᵤₜₗₑₜ) represents molar fraction of ¹³CO₂ in the unreacted CO₂; and
x(¹³C_{content}) represents x(¹³C_{feed}) or x(¹³Cₒᵤₜₗₑₜ).

Δ¹³C may be about 0.001%, at least about 0.002%, at least about 0.004%, at least about 0.005%, at least about 0.009%, at least about 0.01%, at least about 0.011%, at least about 0.014%, at least about 0.015%, at least about 0.02%, at least about 0.04%, at least about 0.12%, at least about 0.16%, at least about 0.18%, at least about 0.2%, at least about 0.22%, at least about 0.3%, at least about 0.36%, at least about 0.4%, at least about 0.5%, at least about 1%, at least about 5%, at least about 10%, at least about 20%, at least about 30%, at least about 50%, at least about 70%, at least about 90%, at least about 95%, at least about 99%, at least about 99.9%; or from about 0.001% to about 99.9%, from about 0.001% to about 99%, from about 0.001% to about 95%, from about 0.001% to about 90%, from about 0.001% to about 70%, from about 0.001% to about 50%, from about 0.001% to about 30%, from about 0.001% to about 20%, from about 0.001% to about 10%, from about 0.001% to about 5%, from about 0.001% to about 1%, from about 0.001% to about 0.5%, from about 0.001% to about 0.4%, from about 0.001% to about 0.36%, from about 0.001% to about 0.3%, from about 0.001% to about 0.22%, from about 0.001% to about 0.2%, from about 0.001% to about 0.18%, from about 0.001% to about 0.16%, from about 0.001% to about 0.12%, from about 0.001% to about 0.04%, from about 0.001% to about 0.02%, from about 0.001% to about 0.015%, from about 0.001% to about 0.014%, from about 0.001% to about 0.011%, from about 0.001% to about 0.01%, from about 0.001% to about 0.009%, from about 0.001% to about 0.005%, from about 0.001% to about 0.004%, from about 0.001% to about 0.002%, from about 0.002% to about 99.9%, from about 0.002% to about 99%, from about 0.002% to about 95%, from about 0.002% to about 90%, from about 0.002% to about 70%, from about 0.002% to about 50%, from about 0.002% to about 30%, from about 0.002% to about 20%, from about 0.002% to about 10%, from about 0.002% to about 5%, from about 0.002% to about 1%, from about 0.002% to about 0.5%, from about 0.002% to about 0.4%, from about 0.002% to about 0.36%, from about 0.002% to about 0.3%, from about 0.002% to about 0.22%, from about 0.002% to about 0.2%, from about 0.002% to about 0.18%, from about 0.002% to about 0.16%, from about 0.002% to about 0.12%, from about 0.002% to about 0.04%, from about 0.002% to about 0.02%, from about 0.002% to about 0.015%, from about 0.002% to about 0.014%, from about 0.002% to about 0.011%, from about 0.002% to about 0.01%, from about 0.002% to about 0.009%, from about 0.002% to about 0.005%, from about 0.002% to about 0.004%, from about 0.004% to about 99.9%, from about 0.004% to about 99%, from about 0.004% to about 95%, from about 0.004% to about 90%, from about 0.004% to about 70%, from about 0.004% to about 50%, from about 0.004% to about 30%, from about 0.004% to about 20%, from about 0.004% to about 10%, from about 0.004% to about 5%, from about 0.004% to about 1%, from about 0.004% to about 0.5%, from about 0.004% to about 0.4%, from about 0.004% to about 0.36%, from about 0.004% to about 0.3%, from about 0.004% to about 0.22%, from about 0.004% to about 0.2%, from about 0.004% to about 0.18%, from about 0.004% to about 0.16%, from about 0.004% to about 0.12%, from about 0.004% to about 0.04%, from about 0.004% to about 0.02%, from about 0.004% to about 0.015%, from about 0.004% to about 0.014%, from about 0.004% to about 0.011%, from about 0.004% to about 0.01%, from about 0.004% to about 0.009%, from about 0.004% to about 0.005%, from about 0.005% to about 99.9%, from about 0.005% to about 99%, from about 0.005% to about 95%, from about 0.005% to about 90%, from about 0.005% to about 70%, from about 0.005% to about 50%, from about 0.005% to about 30%, from about 0.005% to about 20%, from about 0.005% to about 10%, from about 0.005% to about 5%, from about 0.005% to about 1%, from about 0.005% to about 0.5%, from about 0.005% to about 0.4%, from about 0.005% to about 0.36%, from about 0.005% to about 0.3%, from about 0.005% to about 0.22%, from about 0.005% to about 0.2%, from about 0.005% to about 0.18%, from about 0.005% to about 0.16%, from about 0.005% to about 0.12%, from about 0.005% to about 0.04%, from about 0.005% to about 0.02%, from about 0.005% to about 0.015%, from about 0.005% to about 0.014%, from about 0.005% to about 0.011%, from about 0.005% to about 0.01%, from about 0.005% to about 0.009%, from about 0.009% to about 99.9%, from about 0.009% to about 99%, from about 0.009% to about 95%, from about 0.009% to about 90%, from about 0.009% to about 70%, from about 0.009% to about 50%, from about 0.009% to about 30%, from about 0.009% to about 20%, from about 0.009% to about 10%, from about 0.009% to about 5%, from about 0.009% to about 1%, from about 0.009% to about 0.5%, from about 0.009% to about 0.4%, from about 0.009% to about 0.36%, from about 0.009% to about 0.3%, from about 0.009% to about 0.22%, from about 0.009% to about 0.2%, from about 0.009% to about 0.18%, from about 0.009% to about 0.16%, from about 0.009% to about 0.12%, from about 0.009% to about 0.04%, from about 0.009% to about 0.02%, from about 0.009% to about 0.015%, from about 0.009% to about 0.014%, from about 0.009% to about 0.011%, from about 0.009% to about 0.01%, from about 0.01% to about 99.9%, from about 0.01% to about 99%, from about 0.01% to about 95%, from about 0.01% to about 90%, from about 0.01% to about 70%, from about 0.01% to about 50%, from about 0.01% to about 30%, from about 0.01% to about 20%, from about 0.01% to about 10%, from about 0.01% to about 5%, from about 0.01% to about 1%, from about 0.01% to about 0.5%, from about 0.01% to about 0.4%, from about 0.01% to about 0.36%, from about 0.01% to about 0.3%, from about 0.01% to about 0.22%, from about 0.01% to about 0.2%, from about 0.01% to about 0.18%, from about 0.01% to about 0.16%, from about 0.01% to about 0.12%, from about 0.01% to about 0.04%, from about 0.01% to about 0.02%, from about 0.01% to about 0.015%, from about 0.01% to about 0.014%, from about 0.01% to about 0.011%, from about 0.011% to about 99.9%, from about 0.011% to about 99%, from about 0.011% to about 95%, from about 0.011% to about 90%, from about 0.011% to about 70%, from about 0.011% to about 50%, from about 0.011% to about 30%, from about 0.011% to about 20%, from about 0.011% to about 10%, from about 0.011% to about 5%, from about 0.011% to about 1%, from about 0.011% to about 0.5%, from about 0.011% to about 0.4%, from about 0.011% to about 0.36%, from about 0.011% to about 0.3%, from about 0.011% to about 0.22%, from about 0.011% to about 0.2%, from about 0.011% to about 0.18%, from about 0.011% to about 0.16%, from about 0.011% to about 0.12%, from about 0.011% to about 0.04%, from about 0.011% to about 0.02%, from about 0.011% to about 0.015%, from about 0.011% to about 0.014%, from about 0.014% to about 99.9%, from about 0.014% to about 99%, from about 0.014% to about 95%, from about 0.014% to about 90%, from about 0.014% to about 70%, from about 0.014% to about 50%, from about 0.014% to about 30%, from about 0.014% to about 20%, from about 0.014% to about 10%, from about 0.014% to about 5%, from about 0.014% to about 1%, from about 0.014% to about 0.5%, from about 0.014% to about 0.4%, from about 0.014% to about 0.36%, from about 0.014% to about 0.3%, from about 0.014% to about 0.22%, from about 0.014% to about 0.2%, from about 0.014% to about 0.18%, from about 0.014% to about 0.16%, from about 0.014% to about 0.12%, from about 0.014% to about 0.04%, from about 0.014% to about 0.02%, from about 0.014% to about 0.015%, from about 0.015% to about 99.9%, from about 0.015% to about 99%, from about 0.015% to about 95%, from about 0.015% to about 90%, from about 0.015% to about 70%, from about 0.015% to about 50%, from about 0.015% to about 30%, from about 0.015% to about 20%, from about 0.015% to about 10%, from about 0.015% to about 5%, from about 0.015% to about 1%, from about 0.015% to about 0.5%, from about 0.015% to about 0.4%, from about 0.015% to about 0.36%, from about 0.015% to about 0.3%, from about 0.015% to about 0.22%, from about 0.015% to about 0.2%, from about 0.015% to about 0.18%, from about 0.015% to about 0.16%, from about 0.015% to about 0.12%, from about 0.015% to about 0.04%, from about 0.015% to about 0.02%, from about 0.02% to about 99.9%, from about 0.02% to about 99%, from about 0.02% to about 95%, from about 0.02% to about 90%, from about 0.02% to about 70%, from about 0.02% to about 50%, from about 0.02% to about 30%, from about 0.02% to about 20%, from about 0.02% to about 10%, from about 0.02% to about 5%, from about 0.02% to about 1%, from about 0.02% to about 0.5%, from about 0.02% to about 0.4%, from about 0.02% to about 0.36%, from about 0.02% to about 0.3%, from about 0.02% to about 0.22%, from about 0.02% to about 0.2%, from about 0.02% to about 0.18%, from about 0.02% to about 0.16%, from about 0.02% to about 0.12%, from about 0.02% to about 0.04%, from about 0.04% to about 99.9%, from about 0.04% to about 99%, from about 0.04% to about 95%, from about 0.04% to about 90%, from about 0.04% to about 70%, from about 0.04% to about 50%, from about 0.04% to about 30%, from about 0.04% to about 20%, from about 0.04% to about 10%, from about 0.04% to about 5%, from about 0.04% to about 1%, from about 0.04% to about 0.5%, from about 0.04% to about 0.4%, from about 0.04% to about 0.36%, from about 0.04% to about 0.3%, from about 0.04% to about 0.22%, from about 0.04% to about 0.2%, from about 0.04% to about 0.18%, from about 0.04% to about 0.16%, from about 0.04% to about 0.12%, from about 0.12% to about 99.9%, from about 0.12% to about 99%, from about 0.12% to about 95%, from about 0.12% to about 90%, from about 0.12% to about 70%, from about 0.12% to about 50%, from about 0.12% to about 30%, from about 0.12% to about 20%, from about 0.12% to about 10%, from about 0.12% to about 5%, from about 0.12% to about 1%, from about 0.12% to about 0.5%, from about 0.12% to about 0.4%, from about 0.12% to about 0.36%, from about 0.12% to about 0.3%, from about 0.12% to about 0.22%, from about 0.12% to about 0.2%, from about 0.12% to about 0.18%, from about 0.12% to about 0.16%, from about 0.16% to about 99.9%, from about 0.16% to about 95%, from about 0.16% to about 90%, from about 0.16% to about 70%, from about 0.16% to about 50%, from about 0.16% to about 30%, from about 0.16% to about 20%, from about 0.16% to about 10%, from about 0.16% to about 5%, from about 0.16% to about 1%, from about 0.16% to about 0.5%, from about 0.16% to about 0.4%, from about 0.16% to about 0.36%, from about 0.16% to about 0.3%, from about 0.16% to about 0.22%, from about 0.16% to about 0.2%, from about 0.16% to about 0.18%, from about 0.18% to about 99.9%, from about 0.18% to about 99%, from about 0.18% to about 95%, from about 0.18% to about 90%, from about 0.18% to about 70%, from about 0.18% to about 50%, from about 0.18% to about 30%, from about 0.18% to about 20%, from about 0.18% to about 10%, from about 0.18% to about 5%, from about 0.18% to about 1%, from about 0.18% to about 0.5%, from about 0.18% to about 0.4%, from about 0.18% to about 0.36%, from about 0.18% to about 0.3%, from about 0.18% to about 0.22%, from about 0.02% to about 0.2%, from about 0.02% to about 99.9%, from about 0.02% to about 99%, from about 0.02% to about 95%, from about 0.02% to about 90%, from about 0.02% to about 70%, from about 0.02% to about 50%, from about 0.02% to about 30%, from about 0.02% to about 20%, from about 0.02% to about 10%, from about 0.02% to about 5%, from about 0.02% to about 1%, from about 0.02% to about 0.5%, from about 0.02% to about 0.4%, from about 0.02% to about 0.36%, from about 0.02% to about 0.3%, from about 0.02% to about 0.22%, from about 0.22% to about 99.9%, from about 0.22% to about 99%, from about 0.22% to about 95%, from about 0.22% to about 90%, from about 0.22% to about 70%, from about 0.22% to about 50%, from about 0.22% to about 30%, from about 0.22% to about 20%, from about 0.22% to about 10%, from about 0.22% to about 5%, from about 0.22% to about 1%, from about 0.22% to about 0.5%, from about 0.22% to about 0.4%, from about 0.22% to about 0.36%, from about 0.22% to about 0.3%, from about 0.3% to about 99.9%, from about 0.3% to about 99%, from about 0.3% to about 95%, from about 0.3% to about 90%, from about 0.3% to about 70%, from about 0.3% to about 50%, from about 0.3% to about 30%, from about 0.3% to about 20%, from about 0.3% to about 10%, from about 0.3% to about 5%, from about 0.3% to about 1%, from about 0.3% to about 0.5%, from about 0.3% to about 0.4%, from about 0.3% to about 0.36%, from about 0.36% to about 99.9%, from about 0.36% to about 99%, from about 0.36% to about 95%, from about 0.36% to about 90%, from about 0.36% to about 70%, from about 0.36% to about 50%, from about 0.36% to about 30%, from about 0.36% to about 20%, from about 0.36% to about 10%, from about 0.36% to about 5%, from about 0.36% to about 1%, from about 0.36% to about 0.5%, from about 0.36% to about 0.4%, from about 0.4% to about 99.9%, from about 0.4% to about 99%, from about 0.4% to about 95%, from about 0.4% to about 90%, from about 0.4% to about 70%, from about 0.4% to about 50%, from about 0.4% to about 30%, from about 0.4% to about 20%, from about 0.4% to about 10%, from about 0.4% to about 5%, from about 0.4% to about 1%, from about 0.4% to about 0.5%, from about 0.5% to about 99.9%, from about 0.5% to about 99%, from about 0.5% to about 95%, from about 0.5% to about 90%, from about 0.5% to about 70%, from about 0.5% to about 50%, from about 0.5% to about 30%, from about 0.5% to about 20%, from about 0.5% to about 10%, from about 0.5% to about 5%, from about 0.5% to about 1%, from about 1% to about 99.9%, from about 1% to about 99%, from about 1% to about 95%, from about 1% to about 90%, from about 1% to about 70%, from about 1% to about 50%, from about 1% to about 30%, from about 1% to about 20%, from about 1% to about 10%, from about 1% to about 5%, from about 5% to about 99.9%, from about 5% to about 99%, from about 5% to about 95%, from about 5% to about 90%, from about 5% to about 70%, from about 5% to about 50%, from about 5% to about 30%, from about 5% to about 20%, from about 5% to about 10%, from about 10% to about 99.9%, from about 10% to about 99%, from about 10% to about 95%, from about 10% to about 90%, from about 10% to about 70%, from about 10% to about 50%, from about 10% to about 30%, from about 10% to about 20%, from about 20% to about 99.9%, from about 20% to about 99%, from about 20% to about 95%, from about 20% to about 90%, from about 20% to about 70%, from about 20% to about 50%, from about 20% to about 30%, from about 30% to about 99.9%, from about 30% to about 99%, from about 30% to about 95%, from about 30% to about 90%, from about 30% to about 70%, from about 30% to about 50%, from about 50% to about 99.9%, from about 50% to about 99%, from about 50% to about 95%, from about 50% to about 90%, from about 50% to about 70%, from about 70% to about 99.9%, from about 70% to about 99%, from about 70% to about 95%, from about 70% to about 90%, from about 90% to about 99.9%, from about 90% to about 99%, from about 90% to about 95%, from about 95% to about 99.9%, from about 95% to about 99%, from about 99% to about 99.9%; or at most about 0.001%, at most about 0.002%, at most about 0.004%, at most about 0.005%, at most about 0.009%, at most about 0.01%, at most about 0.011%, at most about 0.014%, at most about 0.015%, at most about 0.02%, at most about 0.04%, at most about 0.12%, at most about 0.16%, at most about 0.18%, at most about 0.2%, at most about 0.22%, at most about 0.3%, at most about 0.36%, at most about 0.4%, at most about 0.5%, at least about 1%, at least about 5%, at least about 10%, at least about 20%, at least about 30%, at least about 50%, at least about 70%, at least about 90%, at least about 95%, at least about 99%, at least about 99.9%; or about 0.001%, about 0.002%, about 0.004%, about 0.005%, about 0.009%, about 0.01%, about 0.011%, about 0.014%, about 0.015%, about 0.02%, about 0.04%, about 0.12%, about 0.16%, about 0.18%, about 0.2%, about 0.22%, about 0.3%, about 0.36%, about 0.4%, about 0.5%, at least about 1%, at least about 5%, at least about 10%, at least about 20%, at least about 30%, at least about 50%, at least about 70%, at least about 90%, at least about 95%, at least about 99%, at least about 99.9%, or any ranges and values therebetween. In a preferred embodiment, the present disclosure discloses a method wherein Δ¹³C is at least about 0.1%. In a further preferred embodiment, the present disclosure discloses a method wherein Δ¹³C is at least about 0.2%. In a further preferred embodiment, the present disclosure discloses a method wherein Δ¹³C is at least about 0.3%. In yet another preferred embodiment, the present disclosure discloses a method wherein Δ¹³C is about 0.1% to about 99%.

The unreacted CO₂ in the outlet stream may be separated from gaseous reduction products by various means, for example by condensation. Condensation serves to remove the compound with the highest boiling point. Examples of by-products that can be removed are CO, H₂, syngas, or CH₄. The condensation may be performed at a certain pressure and temperature and may be further or subsequently separated on a membrane in a membrane distillation process, for example a polysulfone membrane, or more preferentially a polysulfone membrane doped with selenium, bromide or similar compounds. The membrane distillation after the condensation step may comprise a flat membrane cell in a cross-flow, counter-current flow or a co-current flow configuration. In a preferred embodiment, the present disclosure discloses a method, wherein step (iii) comprises separating unreacted CO₂ from product by condensation.

In some embodiments, the condensation may be performed at a pressure range of at least about 0.5 bar, at least about 1 bar, at least about 2 bar, at least about 4 bar, at least about 6 bar, at least about 8 bar, at least about 10 bar, at least about 12 bar; or from about 0.5 bar to about 12 bar, from about 0.5 bar to about 10 bar, from about 0.5 bar to about 8 bar, from about 0.5 bar to about 6 bar, from about 0.5 bar to about 4 bar, from about 0.5 bar to about 2 bar, from about 0.5 bar to about 1 bar, from about 1 bar to about 12 bar, from about 1 bar to about 10 bar, from about 1 bar to about 8 bar, from about 1 bar to about 6 bar, from about 1 bar to about 4 bar, from about 1 bar to about 2 bar, from about 2 bar to about 12 bar, from about 2 bar to about 10 bar, from about 2 bar to about 8 bar, from about 2 bar to about 6 bar, from about 2 bar to about 4 bar, from about 4 bar to about 12 bar, from about 4 bar to about 10 bar, from about 4 bar to about 8 bar, from about 4 bar to about 6 bar, from about 6 bar to about 12 bar, from about 6 bar to about 10 bar, from about 6 bar to about 8 bar, from about 8 bar to about 12 bar, from about 8 bar to about 10 bar, from about 10 bar to about 12 bar; or at most about 0.5 bar, at most about 1 bar, at most about 2 bar, at most about 4 bar, at most about 6 bar, at most about 8 bar, at most about 10 bar, at most about 12 bar; or about 0.5 bar, about 1 bar, about 2 bar, about 4 bar, about 6 bar, about 8 bar, about 10 bar, about 12 bar, or any ranges or values therebetween.

In some other embodiments, the condensation may be performed a temperature range of at least about −10° C., at least about −30° C., at least about −50° C., at least about −70° C., at least about −90° C., at least about −110° C., at least about −130° C.; or from about −10° C. to about −130° C., from about −10° C. to about −110° C., from about −10° C. to about −90° C., from about −10° C. to about −70° C., from about −10° C. to about −50° C., from about −10° C. to about −30° C., from about −30° C. to about −130° C., from about −30° C. to about −110° C., from about −30° C. to about −90° C., from about −30° C. to about −70° C., from about −30° C. to about −50° C., from about −50° C. to about −130° C., from about −50° C. to about −110° C., from about −50° C. to about −90° C., from about −50° C. to about −70° C., from about −70° C. to about −130° C., from about −70° C. to about −110° C., from about −70° C. to about −90° C., from about −90° C. to about −130° C., from about −90° C. to about −110° C., from about −110° C. to about −130° C.; or at most about −10° C., at most about −30° C., at most about −50° C., at most about −70° C., at most about −90° C., at most about −110° C., at most about −130° C.; or about −10° C., about −30° C., about −50° C., about −70° C., about −90° C., about −110° C., about −130° C., or any ranges or values therebetween.

The liquid products may be separated from the catholyte by various means, for example by membrane distillation. The membrane distillation may be performed at a certain pressure and temperature, while the membrane used may comprise PTFE, PP, PVDF or mixtures thereof. The membrane distillation setup may also comprise a flat membrane cell in a cross-flow, counter-current flow or a co-current flow configuration.

In some embodiments, the membrane distillation may be performed in a pressure range of at least about 0.01 bar, at least about 0.02 bar, at least about 0.05 bar, at least about 0.1 bar, at least about 0.25 bar, at least about 0.5 bar, at least about 0.75 bar, at least about 1 bar, at least about 2 bar, at least about 3 bar; or from about 0.01 bar to about 3 bar, from about 0.01 bar to about 2 bar, from about 0.01 bar to about 1 bar, from about 0.01 bar to about 0.75 bar, from about 0.01 bar to about 0.5 bar, from about 0.01 bar to about 0.25 bar, from about 0.01 bar to about 0.1 bar, from about 0.01 bar to about 0.05 bar, from about 0.01 bar to about 0.02 bar, from about 0.02 bar to about 3 bar, from about 0.02 bar to about 2 bar, from about 0.02 bar to about 1 bar, from about 0.02 bar to about 0.75 bar, from about 0.02 bar to about 0.5 bar, from about 0.02 bar to about 0.25 bar, from about 0.02 bar to about 0.1 bar, from about 0.02 bar to about 0.05 bar, from about 0.05 bar to about 3 bar, from about 0.05 bar to about 2 bar, from about 0.05 bar to about 1 bar, from about 0.05 bar to about 0.75 bar, from about 0.05 bar to about 0.5 bar, from about 0.05 bar to about 0.25 bar, from about 0.05 bar to about 0.1 bar, from about 0.1 bar to about 3 bar, from about 0.1 bar to about 2 bar, from about 0.1 bar to about 1 bar, from about 0.1 bar to about 0.75 bar, from about 0.1 bar to about 0.5 bar, from about 0.1 bar to about 0.25 bar, from about 0.25 bar to about 3 bar, from about 0.25 bar to about 2 bar, from about 0.25 bar to about 1 bar, from about 0.25 bar to about 0.75 bar, from about 0.25 bar to about 0.5 bar, from about 0.5 bar to about 3 bar, from about 0.5 bar to about 2 bar, from about 0.5 bar to about 1 bar, from about 0.5 bar to about 0.75 bar, from about 0.75 bar to about 3 bar, from about 0.75 bar to about 2 bar, from about 0.75 bar to about 1 bar, from about 1 bar to about 3 bar, from about 1 bar to about 2 bar, from about 2 bar to about 3 bar; or at most about 0.01 bar, at most about 0.02 bar, at most about 0.05 bar, at most about 0.1 bar, at most about 0.25 bar, at most about 0.5 bar, at most about 0.75 bar, at most about 1 bar, at most about 2 bar, at most about 3 bar; or about 0.01 bar, about 0.02 bar, about 0.05 bar, about 0.1 bar, about 0.25 bar, about 0.5 bar, about 0.75 bar, about 1 bar, about 2 bar, about 3 bar, or any ranges or values therebetween. In a preferred embodiment, the membrane distillation is performed in a range from about 0.02 bar to about 1 bar.

In some other embodiments, the membrane distillation may be performed at a temperature range of at least about 10° C., at least about 20° C., at least about 40° C., at least about 60° C., at least about 80° C., at least about 90° C.; or from about 10° C. to about 90° C., from about 10° C. to about 80° C., from about 10° C. to about 60° C., from about 10° C. to about 40° C., from about 10° C. to about 20° C., from about 20° C. to about 90° C., from about 20° C. to about 80° C., from about 20° C. to about 60° C., from about 20° C. to about 40° C., from about 40° C. to about 90° C., from about 40° C. to about 80° C., from about 40° C. to about 60° C., from about 60° C. to about 90° C., from about 60° C. to about 80° C., from about 80° C. to about 90° C.; or at most about 10° C., at most about 20° C., at most about 40° C., at most about 60° C., at most about 80° C., at most about 90° C.; or about 10° C., about 20° C., about 40° C., about 60° C., about 80° C., about 90° C., or any ranges or values therebetween.

The present disclosure also provides for a system for electrochemical ¹³C-isotope enrichment by electrochemical reduction, comprising:
an electrochemical station with a gas diffusion cathode, a porous metal anode, an ion exchange membrane and an electrolyte;
a product separation station membrane for separation of CO₂ or distillation; and
a recirculation station or chain of consecutive reactors.

The gas diffusion cathode may comprise porous carbon paper coated with catalyst layer on one side and hydrophobic layer on the other side that allows a diffusion of CO₂ and electrolyte to catalyst with products diffusing back to the gas phase while preventing leakage of electrolyte into a gas phase.

The porous metal anode may comprise porous Nickel foam coated with Nickel-Iron oxide-hydroxide for greater stability.

The ion exchange membrane may comprise an anion exchange membrane that prevents the mixing cathode and anode electrolyte.

The electrolyte may comprise potassium hydroxide water solution where the concentration of KOH can be from 1 to 10 mol/L.

The catalyst may comprise copper nanoparticles with size from 10 to 200 nm more preferably from 20 to 100 nm.

The catalyst loading may be from 0.5 to 10 mg per cm², more preferably from 1 to 5 mg per cm².

The gas products separation station may comprise a heat exchanger for partial condensation of the gas stream, under the pressure between 1 and 10 bar, preferably between −70° C. and −90° C., and subsequent separation on polysulfone based membrane, preferentially doped with Selenium, Bromide or alike compounds, under the pressure between 1 and 10 bar and in temperature between 20° C. and 50° C.

The liquid products separation station may comprise a membrane distillation device, operating under the pressure between 0.02 and 1 bar, preferably between 20° C. and 80° C., and uses a membrane composed of PTFE, PP, PVDF or mixture of polymers.

The device used for membrane separation may comprise a flat membrane cell, in a cross-flow, counter-current or co-current flow.

### EXAMPLES

Non-limiting examples of the invention and comparative examples will be further described in greater detail by reference to specific examples, which should not be construed as in any way limiting the scope of the invention.

### Material and Methods

Copper nanoparticles (25 nm and 60 nm, 99.99%), silver-copper alloy nanopowder (<100 nm, 98% Ag, 2% Cu), graphite powder (<20 m) and Nafion 117 solution for GDE fabrication, nickel foam, and potassium hydroxide flakes used as electrolyte were acquired from Sigma Aldrich. The Fumasep FAA anionic exchange membrane (AEM) utilized to partition cathode and anode chambers of the cell, carbon black (Vulcan XC-72R) and carbon paper (Freudenberg H14C9) for GDE fabrication were obtained from The Fuel Cell Store. MC-series mass flow controllers and MS-series mass flow meters were obtained from Alicat Scientific, Inc.

The feed stream flow rates in the following Examples were controlled using an Alicat MC-series mass flow controller set to standard temperature and pressure (STP, 25° C., 1 atm) conditions, while the outlet stream flow rates in the following Examples were measured using an Alicat MS-series mass flow-meter set to standard temperature and pressure (STP, 25° C., 1 atm) conditions.

### Example 1: Process for ¹³C Enrichment

A general process for ¹³C enrichment is shown in FIG. 1 and FIG. 2 and described in detail in the “Detailed Disclosure of Drawings” section above. The main reactions taking place within the described cell are given in Table 1.

In one embodiment, potassium-hydroxide-based electrolytes are deployed, and the cathode is a GDE electrode based on copper (Cu) or silver (Ag), while the anode is primarily nickel (Ni). The gaseous stream leaving the reactor consists of gaseous products and unreacted CO₂. The unreacted CO₂ may be recirculated and is enriched with ¹³C in every pass. The unreacted CO₂ may first be separated from the other products by means of liquid condensation with liquid nitrogen, while the remaining components may be further separated on a polysulfone based membrane into its separate components. The separation of liquid products is achieved by vacuum membrane distillation process. A minor part of the catholyte may be removed and valorized as e.g. cleaning medium for the food processing industry.

TABLE 1
Primary reactions occurring in the electrochemical cell

| Cathode reactions | Anode reactions |
|---|---|
| CO₂ + 2H⁺ + 2e⁻ ↔ CO + H₂O | 4OH⁻ ↔ O₂ + 2H₂O + 2e⁻ |
| 2CO₂ + 12H⁺ + 12e⁻ ↔ C₂H₄ + 4H₂O | |
| 2CO₂ + 12H⁺ + 12e⁻ ↔ C₂H₅OH + 3H₂O | |
| 2CO₂ + 8H⁺ + 8e⁻ ↔ CH₃COOH + 2H₂O | |
| 2H⁺ + 2e⁻ ↔ H₂ | |

### Example 2: Cathode Preparation

### Example 2a: Metal Nanoparticle Dispersion

Metal nanoparticles (50-150 mg) were dispersed in a water-isopropanol mixture (10 ml) in a ratio of 1:3. To homogenize the dispersion, Nafion 117 solution (0.5 ml) was further added and the mixture was sonicated by ultrasonic homogenizer for 2 minutes. The type of metal nanoparticles and their average particle size are given in Table 2.

TABLE 2
Metal nanoparticles (M-NP) dispersion preparations

| M-NP Dispersions | Metal | Average size/nm |
|---|---|---|
| M-1 | Cu | 25 |
| M-2 | Cu | 60 |
| M-3 | Ag | 100 |

### Example 2b: Carbon Nanoparticle Dispersion

Carbon nanoparticle dispersions were used to form a gas dispersion layer.

To form the dispersions, carbon particles (100 mg) were dispersed in a water-isopropanol mixture in a ratio of 1:3. To homogenize the dispersion, Nafion 117 solution (0.5 ml) was added and the mixture sonicated by ultrasonic homogenizer for 2 minutes. The type of carbon nanoparticles and their average particle sizes are given in Table 3.

TABLE 3
Carbon nanoparticles (C-NP) dispersion preparations

| C-NP Dispersions | Carbon | Average size/nm |
|---|---|---|
| C-1 | Carbon black XC-72 | 25 |
| C-2 | Graphene | 100 |
| C-3 | Graphite | 5000-20000 |

### Example 2c: GDE Fabrication

TABLE 4
Prepared GDE cathodes

| Cathode no. | Layer 1 | Layer 2 | Layer 3 |
|---|---|---|---|
| GDE-1 | M-1 | C-1 | C-3 |
| GDE-2 | M-2 | C-1 | C-3 |
| GDE-3 | M-3 | C-1 | C-3 |
| GDE-4 | M-1 | C-2 | C-3 |
| GDE-5 | M-2 | C-2 | C-3 |
| GDE-6 | M-3 | C-2 | C-3 |
| GDE-7¹ | — | — | — |

¹Carbon paper was used as-is for the electrode.

Gas diffusion electrodes (GDEs) were prepared by spray-casting each layer on porous carbon paper substrate. 1 ml of material was sprayed per 4 cm² of cathode surface area to form each layer. As up to 30% of the dispersion is lost during the spraying process, the final metal loading was estimated to be from 1 mg/cm² to 3 mg/cm². Similar losses are expected when spraying the carbon nanoparticles onto the porous carbon paper substrate. The layer order and materials sprayed are given in Table 4. GDE-7 does not have contain any sprayed material and thus consists purely of carbon paper.

### Example 3: Characterising the GDE Cathode

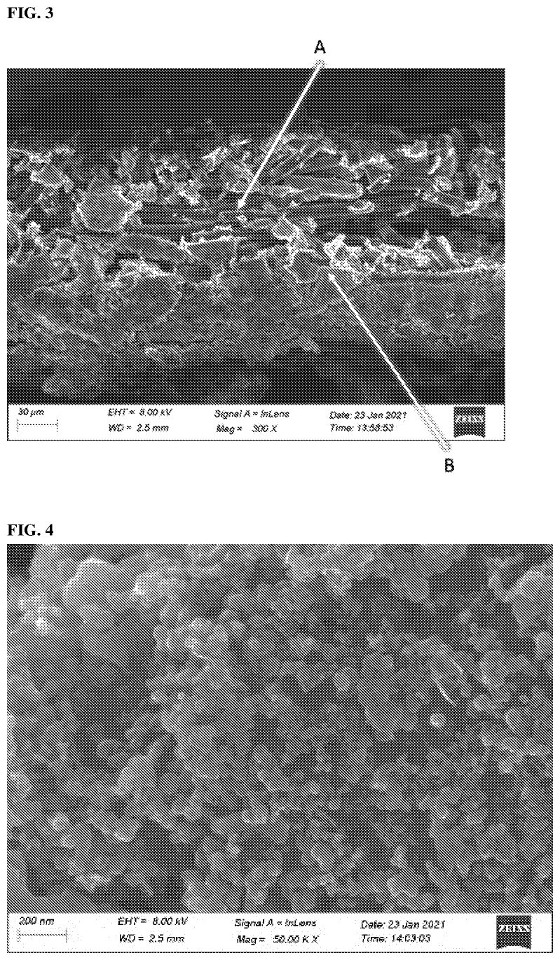

The SEM images of the as-prepared GDE-1 are shown in FIGS. 3 and 4.

The SEM images in FIGS. 3 and 4 show the formation of the gas diffusion layer (GDL) on top of the carbon paper filaments of the porous carbon paper substrate. However, it was noted that the layers formed were much thinner compared to the carbon paper filaments and hence, the three layers of nanoparticles could not be distinguished from each other.

FIG. 4 also shows the rough surface of the GDL formed by layering a first carbon nanoparticle layer and a second carbon microparticle layer on top of the base metal nanoparticle layer.

### Example 4: Results of enrichment

The results of the electrochemical reduction and ¹³C isotope enrichment after a single pass of CO₂ through the flow-cell are given in Table 5. The cathode surface area was 1 cm² in all tests and the internal volume of the cathode chamber is 0.35 cm³.

To detect the unreacted CO₂ in the outlet stream and liquid products in the product stream, a proton transfer reaction time-of-flight mass spectrometry (PTR-TOF-MS) was used. A PTR-TOF-MS Qi8000 from IONICON Inc (Austria) from multiple supply reactive ions tube was utilized where H₃O⁺ ions were used to ionize outgassing species. The drift tube settings were found to be optimal at 114 Td to achieve good sensitivity and resolution. The outlet stream was split and 1.5 sccm of it was mixed with pure nitrogen and directed into the PTR-TOF-MS. Isotope contents and δ¹³C was evaluated based on H₃CO₃+/H₃¹³CO₃+ ions for CO₂.

To determine the ¹²CO₂ and ¹³CO₂ concentrations in the outlet stream during the process, 10 sccm of the outlet stream was split and sampled into a Hiden analytical QGA mass-spectrometer (UK) to monitor changes in the concentration in real time.

### Example 4a: Calculations

Carbon isotope compositions (δ¹³C) were calculated for each test according to the following formula wherein (¹³C/¹²C)ₛₐₘₚₗₑ is measured isotopes ratio after reaction and (¹³C/¹²C)_{standard} is initial isotopes ratio before reaction:

$${δ}^{13} C = ( \frac{{{(}^{13} C {/}^{12} C )}_{s a m p l e}}{{{(}^{13} C {/}^{12} C )}_{standard}} - 1 ) \times 1000 \% .$$

The percent amount of ¹³C was estimated from mass spectra with following formula, wherein n is the amount of the isotope, and x is the molar fraction of ¹³CO₂ in the sample:

$$x {(}^{13} {C}_{c o n t e n t} ) ( \% ) = \frac{n {(}^{13} {CO}_{2} )}{n {(}^{13} {CO}_{2} ) + n {(}^{12} {CO}_{2} )} * 100 \% .$$

The change of the ¹³C concentration (Δ¹³C) between feed and outlet was calculated using the following formula:

$${Δ}^{13} C ( \% ) = x {(}^{13} {C}_{o u t l e t} ) ( \% ) - x {(}^{13} {C}_{feed} ) ( \% )$$

The residence time was calculated using the formula below, wherein the internal volume of the cathode chamber is calculated by measuring the length, and depth of the channel and then subsequently calculating its volume. In subsequent examples, the internal volume of the cathode chamber was measured as 0.35 cm³:

$$residence time = \frac{i n t ernal volume of cathode chamber}{v o l u m etric flow rate} .$$

### Example 4b: Δ¹³C

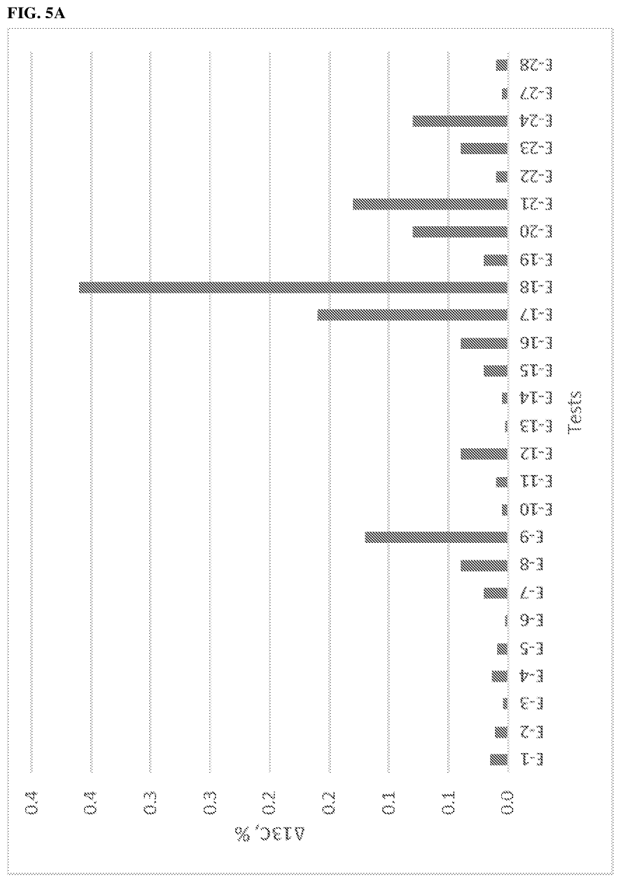

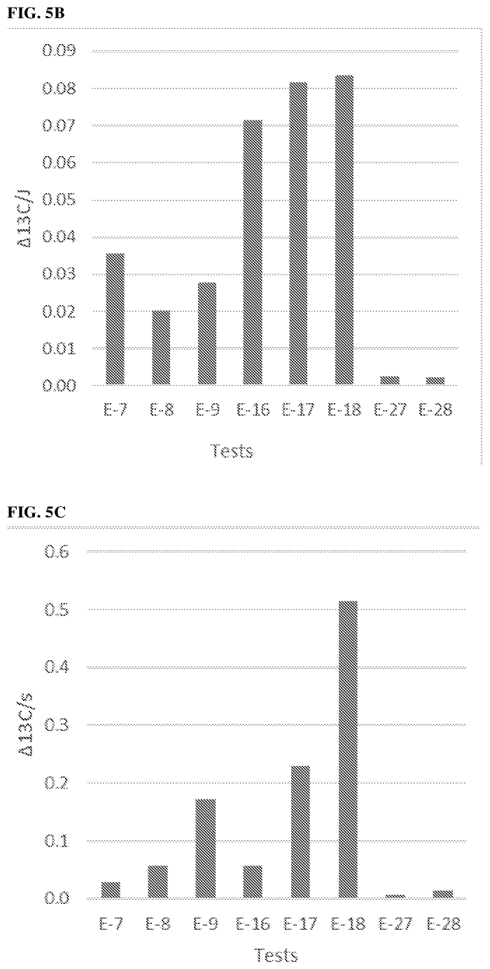

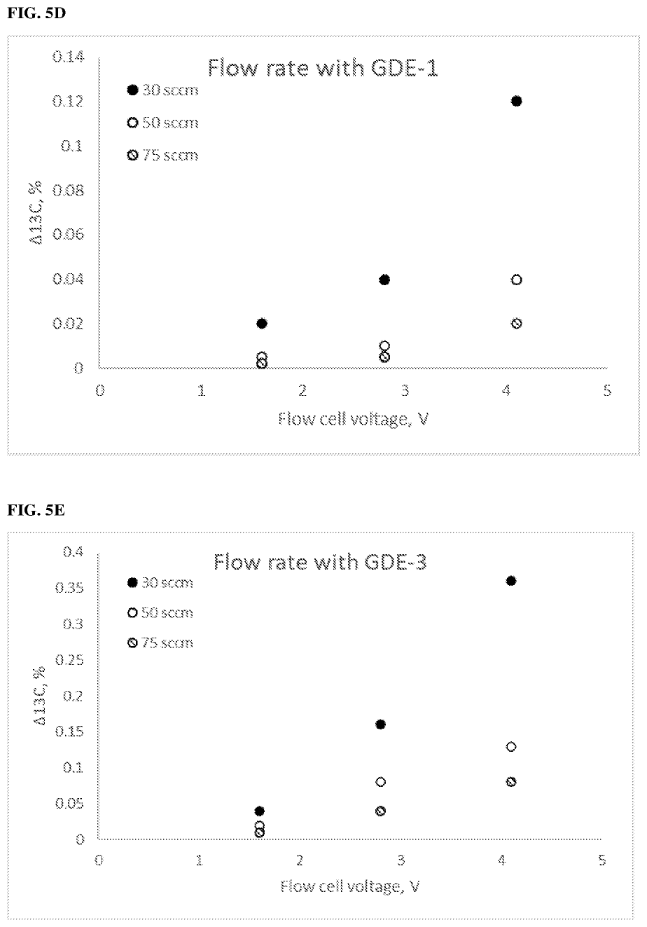

As shown from the results in Table 5 and FIG. 5a, E-18 gave the best Δ¹³C of 0.36% compared to all the other GDE tests. When comparing E-16 to E-18 with the same GDE used, the results indicate that by increasing the current density while keeping the flow rate constant, the best Δ¹³C may be achieved. This indicates that a higher current density is important in producing CO₂ enriched in carbon-13.

Additionally, further tests using GDE-1 comprising Cu nanoparticles as a catalyst layer (first layer) (E-7 to E-9) and tests using GDE-3 comprising Ag nanoparticles as a catalyst layer (first layer) (E-16 to E-18) indicate that Ag was better in enriching ¹³C. At the same flow cell voltage, it was observed that the enrichment for E-18 was 0.36%, as compared to E-9 with a Cu GDE cathode with the same parameters (0.12%).

TABLE 5
Electrochemical enrichment of ¹³CO₂

| | | | | | ¹³C in | | Flow rate | |
|---|---|---|---|---|---|---|---|---|
| | | | | | CO₂ in | Feed | of CO₂ | Total |
| | | Catalyst | Flow cell | Current | feed | flow | detected | conversion |
| | GDE | loading, | voltage, | density, | stream, | rate, | at outlet, | to products, |
| Tests | Cathode | mg/cm² | V | A/cm² | % | sccm | sccm | % |
| E-1 | GDE-1 | 2 | 2.6 | 0.5 | 1.11 | 50 | 41 | 3.51 |
| E-2 | GDE-2 | 2 | 2.6 | 0.5 | 1.11 | 50 | 41 | 2.64 |
| E-3 | GDE-3 | 2 | 2.6 | 0.5 | 1.11 | 50 | 41 | 0.7 |
| E-4 | GDE-4 | 1 | 2.6 | 0.5 | 1.11 | 50 | 41 | 2.78 |
| E-5 | GDE-5 | 1 | 2.6 | 0.5 | 1.11 | 50 | 41 | 2.2 |
| E-6 | GDE-6 | 1 | 2.6 | 0.5 | 1.11 | 50 | 41 | 0.68 |
| E-7 | GDE-1 | 3 | 2.6 | 0.5 | 1.11 | 30 | 25 | 8 |
| E-8 | GDE-1 | 3 | 2.8 | 1.0 | 1.11 | 30 | 20 | 20 |
| E-9 | GDE-1 | 3 | 4.1 | 1.5 | 1.11 | 30 | 17 | 28 |
| E-10 | GDE-1 | 3 | 1.6 | 0.5 | 1.11 | 30 | 25 | 8 |
| E-11 | GDE-1 | 3 | 2.8 | 1 | 1.11 | 30 | 20 | 20 |
| E-12 | GDE-1 | 3 | 4.1 | 1.5 | 1.11 | 30 | 17 | 28 |
| E-13 | GDE-1 | 3 | 1.6 | 0.5 | 1.11 | 50 | 43 | 9 |
| E-14 | GDE-1 | 3 | 2.8 | 1 | 1.11 | 50 | 36 | 5.2 |
| E-15 | GDE-1 | 3 | 4.1 | 1.5 | 1.11 | 50 | 30 | 23 |
| E-16 | GDE-3 | 2 | 1.6 | 0.5 | 1.11 | 30 | 19 | 12 |
| E-17 | GDE-3 | 2 | 2.8 | 1.0 | 1.11 | 30 | 15.3 | 25 |
| E-18 | GDE-3 | 2 | 4.1 | 1.5 | 1.11 | 30 | 15.2 | 31 |
| E-19 | GDE-3 | 2 | 1.6 | 0.5 | 1.11 | 50 | 39.5 | 11 |
| E-20 | GDE-3 | 2 | 2.8 | 1 | 1.11 | 50 | 26 | 9 |
| E-21 | GDE-3 | 2 | 4.1 | 1.5 | 1.11 | 50 | 19 | 21 |
| E-22 | GDE-3 | 2 | 1.6 | 0.5 | 1.11 | 75 | 64 | 17 |
| E-23 | GDE-3 | 2 | 2.8 | 1 | 1.11 | 75 | 55.3 | 25 |
| E-24 | GDE-3 | 2 | 4.1 | 1.5 | 1.11 | 75 | 51 | 19 |
| E-25 | GDE-3 | 2 | 2.8 | 1.0 | 5.58 | 30 | 15.4 | 25 |
| E-26 | GDE-3 | 2 | 2.8 | 1.0 | 88.48 | 30 | 15.4 | 25 |
| E-27 | GDE-7 | 0 | 2.8 | 1.0 | 1.11 | 30 | 20 | 1.0 |
| E-28 | GDE-7 | 0 | 4.1 | 1.5 | 1.11 | 30 | 15.4 | 1.5 |

| | ¹³C in CO₂ | ¹³C in | | | | Energy | Δ ¹³C/s | Δ¹³C/J |
|---|---|---|---|---|---|---|---|---|
| | in outlet | products, | δ¹³C, | Δ¹³C, | time, | input, | (per | (per |
| Tests | stream, % | % | ‰ | % | s | J | time) | energy) |
| E-1 | 1.125 | 1.041 | 16 | 0.015 | 0.42 | 0.546 | 0.036 | 0.028 |
| E-2 | 1.121 | 1.061 | 12 | 0.011 | 0.42 | 0.546 | 0.026 | 0.020 |
| E-3 | 1.114 | 1.091 | 6 | 0.004 | 0.42 | 0.546 | 0.010 | 0.008 |
| E-4 | 1.124 | 1.047 | 14.8 | 0.014 | 0.42 | 0.546 | 0.033 | 0.025 |
| E-5 | 1.119 | 1.069 | 10.5 | 0.009 | 0.42 | 0.546 | 0.022 | 0.017 |
| E-6 | 1.112 | 1.101 | 4 | 0.002 | 0.42 | 0.546 | 0.005 | 0.004 |
| E-7 | 1.130 | 1.010 | 18.22 | 0.02 | 0.7 | 0.56 | 0.029 | 0.036 |
| E-8 | 1.150 | 1.030 | 36.46 | 0.04 | 0.7 | 1.96 | 0.057 | 0.020 |
| E-9 | 1.230 | 0.953 | 109.45 | 0.12 | 0.7 | 4.305 | 0.171 | 0.028 |
| E-10 | 1.130 | 1.010 | 18.22 | 0.02 | 0.7 | 0.56 | 0.029 | 0.036 |
| E-11 | 1.150 | 1.030 | 36.46 | 0.04 | 0.7 | 1.96 | 0.057 | 0.020 |
| E-12 | 1.230 | 0.953 | 109.45 | 0.12 | 0.7 | 4.305 | 0.171 | 0.028 |
| E-13 | 1.115 | 1.079 | 6.76 | 0.005 | 0.42 | 0.336 | 0.012 | 0.015 |
| E-14 | 1.120 | 1.084 | 11.33 | 0.01 | 0.42 | 1.176 | 0.024 | 0.009 |
| E-15 | 1.150 | 1.050 | 38.73 | 0.04 | 0.42 | 2.583 | 0.095 | 0.015 |
| E-16 | 1.150 | 1.041 | 36.46 | 0.04 | 0.7 | 0.56 | 0.057 | 0.071 |
| E-17 | 1.270 | 0.943 | 146.00 | 0.16 | 0.7 | 1.96 | 0.229 | 0.082 |
| E-18 | 1.470 | 0.740 | 329.16 | 0.36 | 0.7 | 4.305 | 0.514 | 0.084 |
| E-19 | 1.130 | 1.035 | 20.46 | 0.02 | 0.42 | 0.336 | 0.048 | 0.060 |
| E-20 | 1.190 | 1.023 | 75.30 | 0.08 | 0.42 | 1.176 | 0.190 | 0.068 |
| E-21 | 1.240 | 1.030 | 121.04 | 0.13 | 0.42 | 2.583 | 0.310 | 0.050 |
| E-22 | 1.120 | 1.052 | 11.33 | 0.01 | 0.28 | 0.224 | 0.036 | 0.045 |
| E-23 | 1.150 | 0.998 | 38.73 | 0.04 | 0.28 | 0.784 | 0.143 | 0.051 |
| E-24 | 1.190 | 0.940 | 75.30 | 0.08 | 0.28 | 1.722 | 0.286 | 0.046 |
| E-25 | 5.760 | 5.390 | 34.23 | 0.18 | 0.7 | 1.96 | 0.257 | 0.092 |
| E-26 | 88.700 | 88.248 | 22.00 | 0.22 | 0.7 | 1.96 | 0.314 | 0.112 |
| E-27 | 1.115 | 1.100 | 6.76 | 0.005 | 0.7 | 1.96 | 0.007 | 0.003 |
| E-28 | 1.120 | 1.099 | 11.33 | 0.01 | 0.7 | 4.305 | 0.014 | 0.002 |

Generally, a larger change in Δ¹³C is observed to correlate with a bigger conversion rate of CO₂ to products. This is likely due to discrimination against the heavy ¹³C isotope when undergoing electroreduction. As noted in Table 5, the ¹³C content of the CO₂ in the outlet stream was observed to increase across all tests, while the ¹³C content of the reduction products were observed to have a lower ¹³C content as compared to the ¹³C content in the initial feed stream.

### Example 4c: Flow Cell Potential and Current Density

The effect of the flow cell voltage was studied, with the results being shown amongst at least E-7 to E-9 and E-16 to E-18. As shown in Table 5 and FIG. 5a, Δ¹³C was observed to increase when a higher voltage was applied. Thus a higher voltage results in more enrichment. Additionally, the method was effective at higher voltages with no significant side reactions, which is an important consideration when performing the method on an industrial scale.

Current is proportionate to the voltage applied, and hence a higher current also directly translates to more enrichment as more energy is provided to the electrode for the electroreduction. To account for different electrode sizes, current density may be used in place of current. Hence as shown in Table 5, current density also directly translates to more enrichment.

### Example 4d: Flow Rate and Residence Time

The flow rate was also studied with results being shown in FIGS. 5d and 5e. The flow rate may be used interchangeably with residence time, as they are inversely proportionate to each other.

FIG. 5d relates to E-7 to E-15, while FIG. 5e relates to E-16 to E-24. The same parameters were used, except that the flow rates were varied between 30 sccm, 50 sccm and 75 sccm (residence times of 0.7 seconds, 0.42 seconds and 0.28 seconds).

As shown in the results, a lower flow rate and a corresponding larger residence time increases Δ¹³C across all tests. At lower flow cell voltages, Δ¹³C was similar between the three tested flow rates, however the differences were quite small. At higher voltages (4.1 V), enrichment was observed at all tested residence times, with the test at 30 sccm having the highest Δ¹³C. Thus a low flow rate is important to increasing the enrichment rate of the present method.

### Example 4e: Efficiency

Δ¹³C was plotted against the residence time (FIG. 5b) and energy input (FIG. 5c) for E-7 to E-9, E-16 to E-18 and E-27 to E-28.

As shown in FIG. 5b, at the same residence time of 0.7 seconds, all tests were found to produce ¹³CO₂ enriched CO₂. E-9 and E-18 in particular had the highest enrichment rate over time.

Comparison of Δ¹³C over energy input (FIG. 5c) indicates both the Ag cathode GDE-3 and Cu cathode GDE-1 are energy-efficient and produced good enrichment rates. E-18 in particular had an enrichment rate of about 0.084% per Joule of energy input, as compared to E-9 having an enrichment rate of 0.028% per Joule of energy input.

### Example 4f: Further enrichment

The method discussed in the previous Examples has been shown to produce ¹³CO₂ enriched stream in a single pass. To further obtain higher enrichment content, the method may be repeated either with recirculation or in a series of electrochemical cells. FIG. 1 demonstrates a recirculation process for producing a ¹³CO₂ enriched stream, while FIG. 2 demonstrates a proposed series of electrochemical cells for producing a ¹³CO₂ enriched stream.

As mentioned, prolonged enrichment may be performed in a single-pass reactor, recirculating reactor (FIG. 1), or in tandem reactors (FIG. 2). To show robustness of the method in this aspect, additional experiments were designed with higher initial ¹³C content in mind (see E-25 and E-26 of Table 5).

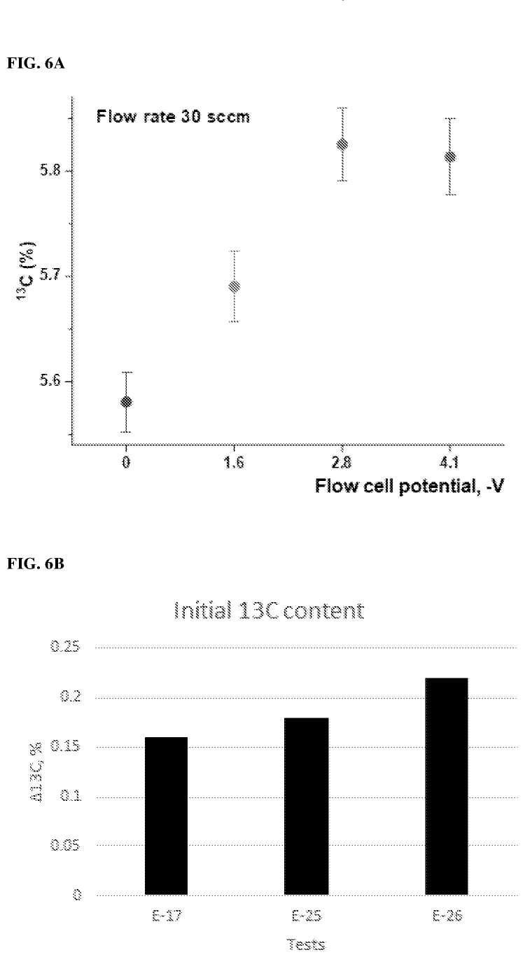

Both E-25 and E-26 have higher initial ¹³C abundances (5.58% and 88.48% respectively) in the feed stream as compared to the natural ¹³C abundance of 1.11% in E-17 as shown in FIG. 6b. As shown in the results in FIG. 6b, substantial enrichment was still observed at higher initial ¹³C abundances, showing that the method can still enrich ¹³C from a higher initial ¹³CO₂ content. Even in E-26 with an initial ¹³C content of 88.48%, a recorded Δ¹³C value of 0.22% was still comparable to the E-25 (0.18%) with a far lower initial ¹³C content at 5.58%.

The enrichment rates were also plotted against the residence time and energy input and shown in FIG. 6c. As shown, the enrichment rate was comparable across all the initial ¹³C content, with E-26 showing the highest enrichment rate. Additionally, energy efficiency was similarly comparable at all initial ¹³C content tested, with E-26 (initial ¹³C content of 88.48%) being the most efficient. Thus the method of the present invention can be applied to feed streams of all ¹³C content. Additionally this also implies that the method can be further applied to a recirculation process, or a tandem process, as discussed in the further Examples.

Additionally, the effect of voltage was also studied on a feed stream of higher ¹³C abundance (5.58%) with the results being shown in FIG. 6a. As shown in FIG. 6a, enrichment was observed at all applied voltages, showing that the presently disclosed enrichment method can be applied to a feed stream with higher ¹³C content at different voltages. Furthermore, the example E-26 shows that the enrichment is still going on even for concentration of ¹³C at 88.48% with the same electrolyte and feed residence time as previous example E-7. These results indicate that tested voltage ranges and parameters are applicable across all feed streams with any level of ¹³C content.

### Example 5: Reduction Products

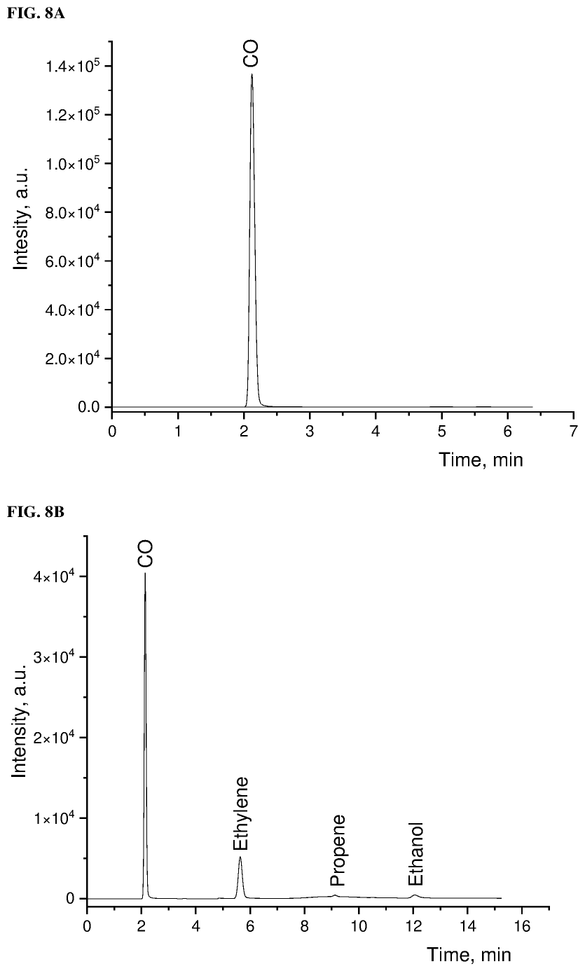

GC results of all major isolated products are shown in FIGS. 8a and 8b.

When GDE-3 was used, CO was the major reduced product observed (see FIG. 8a). On the other hand, when GDE-1 was used, a mixture of CO, ethylene, propene and ethanol were observed (see FIG. 8b). The results indicate that the Cu GDE cathode was able to further reduce the CO₂ from the +4 oxidation states to the −2 oxidation state (as in ethylene), or −3 (as in propene and ethanol). Hence, if the liquid products are desired, the Cu cathode may be used in place of the Ag cathode. Otherwise, the Ag cathode may be used to only produce CO as the only by-product. This is advantageous as the liquid electrolyte would not need to undergo purification to remove side-products, which also translates to lower maintenance costs as well as easier operation.

### Example 6: Recirculation Process

TABLE 6
Recirculation test with E-1

| Cycle number | δ¹³C, ‰ | ¹³C in unreacted CO₂, % |
|---|---|---|
| 1 | 16 | 1.115 |
| 2 | 9 | 1.123 |
| 3 | 10 | 1.131 |
| 4 | 10 | 1.140 |
| 5 | 10 | 1.149 |

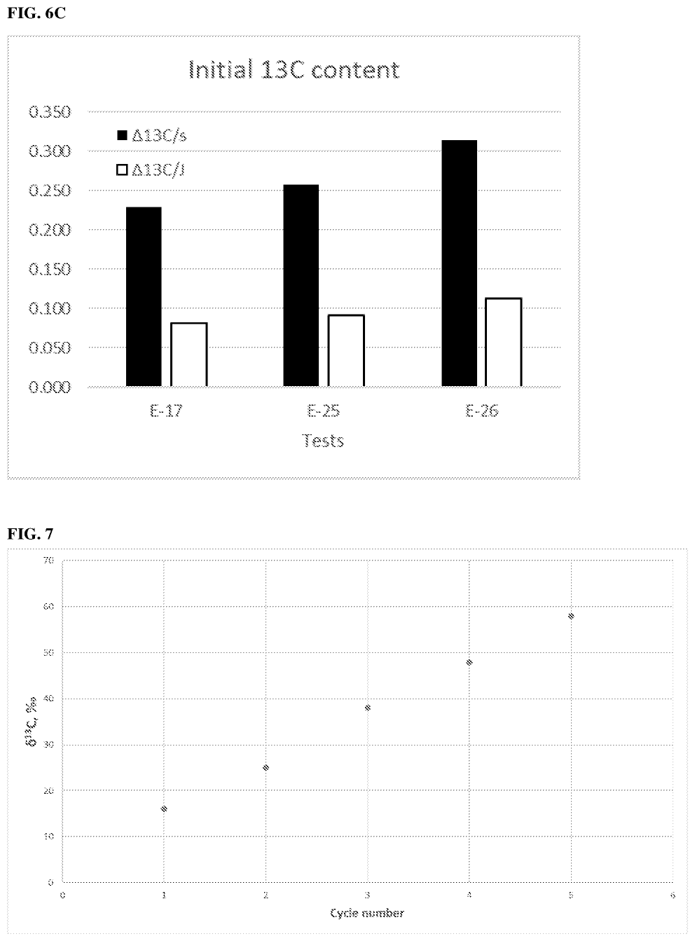

To demonstrate a recirculation electrochemical cell, CO₂ was introduced to the cathode chamber of an electrochemical cell using the same parameters as that of Test E-1. For E-1, the outlet stream was re-directed to the inlet of the same cathode chamber similar to FIG. 1. Results for E-1 are shown in Table 6 and FIG. 7.

As shown from the FIG. 7, an increase in carbon-13 content was observed with the completion of each cycle. At the completion of cycle 5, a δ¹³C percentage of about 60% was observed relative to the ¹³CO₂ content in the initial feed stream. It has also been amply demonstrated in Example 4f that the present method can enrich CO₂ with a higher initial ¹³C content. Thus, the presently disclosed method can be easily adjusted to accommodate a recirculation electrochemical cell for further enrichment of ¹³CO₂.

### Example 7: Industrial Enrichment

In order to further demonstrate the industrial scalability of the method, a study was prepared to determine whether ¹³CO₂ could be enriched to about 5% in a feasible timeframe. In conclusion, higher Δ¹³C is achievable by firstly deploying the optimum process conditions as discussed in the previous examples, and secondly, increasing the size of the GDE cathode. To achieve 5% of ¹³C content in the outlet stream, the electrode surface should preferably be increased by a factor of about ten (while keeping other process parameters constant).

### INDUSTRIAL APPLICABILITY

The present invention relates to a method of enriching ¹³C. The presently disclosed method is cost efficient at only about $0.001 per litre of ¹³CO₂ enriched as compared to current cryogenic processes costing about $16 per litre of ¹³CO enriched. The presently disclosed method is also more energy-efficient, space efficient and more time-efficient compared to conventional process for enriching ¹³C, for example cryogenic distillation. The ¹³C-enriched product can also be applied to many different areas, for example, in drug discovery and validation, reaction mechanism studies, ¹³C-MRI radiology and medical diagnosis. The other products, for example syngas, CO, ethanol, acetic acid or CH₄, may also be applied and used in many different areas, for example in plastics manufacture, fermentation, combustion, or to be further processed into other useful products. Thus this invention is capable of industrial applicability.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of carbon-13 isotope (¹³C) enrichment, the method comprising:
(i) applying a voltage to a cathode located in a cathode chamber of an electrochemical cell;
(ii) flowing a feed stream comprising CO₂ to the cathode chamber, wherein the feed stream contacts the cathode causing reduction of CO₂ to form one or more products; and
(iii) unreacted CO₂ leaving the cathode chamber, the unreacted CO₂ being enriched in ¹³C as compared to the CO₂ in the feed stream, wherein n(¹³CO₂)/(n(¹³CO₂)+n(¹²CO₂)) in the unreacted CO₂ is higher than n(¹³CO₂)/(n(¹³CO₂)+n(¹²CO₂)) in the feed stream, n representing molar amount; wherein the voltage is about 1.5 V to about 5.5 V, and flow rate of the feed stream is selected to provide a residence time of about 0.1 seconds to about 5 seconds in the cathode chamber.

2. The method of claim 1, wherein Δ¹³C is at least about 0.1%, wherein Δ¹³C is calculated as:
$${Δ}^{13} C ( \% ) = x {(}^{13} {C}_{o u t l e t} ) ( \% ) - x {(}^{13} {C}_{feed} ) ( \% )$$
$$wherein$$
$$x {(}^{13} {C}_{c o n t e n t} ) ( \% ) = \frac{n {(}^{13} {CO}_{2} )}{n {(}^{13} {CO}_{2} ) + n {(}^{12} {CO}_{2} )} * 1 \; 00 \% ;$$
n represents molar amount;
x(¹³C_{feed}) represents molar fraction of ¹³CO₂ in the CO₂ in the feed stream;
x(¹³Cₒᵤₜₗₑₜ) represents molar fraction of ¹³CO₂ in the unreacted CO₂; and
x(¹³C_{content}) represents x(¹³C_{feed}) or x(¹³Cₒᵤₜₗₑₜ).

3. The method of claim 2, wherein Δ¹³C is at least about 0.2%, or at least about 0.3%, or about 0.1% to about 99%.

4. (canceled)

5. (canceled)

6. The method of claim 1, wherein the residence time is about 0.1 seconds to about 0.8 seconds.

7. The method of claim 1, wherein the voltage is about 1.5 V to about 4.5 V, or wherein a current is passed through the cathode and current density is about 0.3 A/cm² to about 1.8 A/cm² of cathode surface area.

8. (canceled)

9. The method of claim 1, wherein step (iii) comprises separating unreacted CO₂ from product by condensation.

10. The method of claim 1, further comprising (iv) recirculating the unreacted CO₂ from step (iii) to the cathode chamber.

11. The method of claim 10, wherein step (iv) is performed at least twice.

12. The method of claim 10, wherein the cathode chamber is a cathode chamber of a different electrochemical cell.

13. The method of claim 1, wherein about 5% to about 35% of CO₂ in the feed stream is converted to one or more products.

14. The method of claim 1, wherein the product is selected from the group consisting of ethylene, ethanol, and acetic acid.

15. The method of claim 1, wherein the cathode chamber comprises a catholyte, wherein the catholyte is a hydroxide selected from the group consisting of NaOH, KOH, CsOH, Ca(OH)₂, and mixtures thereof.

16. The method of claim 15, wherein the concentration of hydroxide is about 1 M to about 10 M.

17. The method of claim 1, wherein the cathode is carbon paper, or the cathode comprises a support layered with a first layer of metal nanoparticles, a second layer of carbon nanoparticles, and a third layer of carbon microparticles, and wherein the average diameter of the carbon nanoparticles of the second layer is smaller than the average diameter of the carbon nanoparticles in the third layer, or wherein the cathode is a gas diffusion electrode (GDE).

18. The method of claim 1, wherein the concentration of metal nanoparticles is about 0.5 mg/cm² to about 4 mg/cm² of cathode surface area.

19. The method of claim 18, wherein the support comprises a polymeric porous membrane with a pore size in the range of about 0.1 μm to about 0.8 μm, or wherein the support comprises a polymeric porous membrane and the polymer of the polymeric porous membrane is PTFE or PVDF.

20. (canceled)

21. The method of claim 1, wherein the second layer comprises carbon black nanoparticles, and the third layer comprises graphite microparticles.

22. The method of claim 17, wherein the metal nanoparticles are selected from the group consisting of Cu nanoparticles, Ag nanoparticles, Ni nanoparticles, Co nanoparticles, and Au nanoparticles, or
wherein the average diameter of the metal nanoparticles is in the range of about 10 nm to about 200 nm, or
wherein the average diameter of the carbon nanoparticles in the second layer is in the range of about 25 nm to about 1,000 nm, or
wherein the average diameter of the carbon microparticles in the third layer is in the range of about 4,000 nm to about 20,000 nm.

23. (canceled)

24. (canceled)

25. (canceled)

26. The method of claim 1, wherein the electrochemical cell further comprises an anode, wherein the anode is selected from the group consisting of Ni foam, Ni foam coated with metal oxide hydroxide, or Ni foam coated with metal oxide hydroxide selected from the group consisting of FeOOH, NiOOH, and NiCoOₓ(OH)_{y}.

27. (canceled)

28. (canceled)

29. ¹³CO₂ produced by the method of claim 1.
